(19) United States
(12) Patent Application Publication
(10) Pub. No.: US 2017/0098256 A1
(43) Pub. Date: Apr. 6, 2017

(54) SYSTEM AND METHOD FOR CONVEYING ENTERTAINMENT OR SOCIAL EVENTS

(71) Applicants: Robert A. Long, Detroit, MI (US); Roy E. Sturdivant, Romulus, MI (US); John M. Miller, Romulus, MI (US)

(72) Inventors: Robert A. Long, Detroit, MI (US); Roy E. Sturdivant, Romulus, MI (US); John M. Miller, Romulus, MI (US)

(21) Appl. No.: 15/287,320

(22) Filed: Oct. 6, 2016

Related U.S. Application Data
(60) Provisional application No. 62/237,712, filed on Oct. 6, 2015.

(51) Int. Cl. G06Q 30/02; G06F 17/30; H04W 4/02

(52) U.S. Cl. CPC G06Q 30/0277; H04W 4/023; G06F 17/30867

(57) ABSTRACT

The invention relates to various systems and methods for conveying information associated with one or more entertainment and/or social events to one or more potential participants and/or one or more places of business to one or more potential customers. In one embodiment, the present invention relates to a system and method that permits an individual user to find one or more desired entertainment and/or social events based on one or more criteria (e.g., location, date, geographical proximity, etc.). In another embodiment, the present invention permits one or more business users to advertise, interact and/or promote one or more entertainment and/or social events based, and/or their place of business to one or more individual users/customers.

### RELATED APPLICATION DATA

This patent application claims priority to U.S. Provisional Patent Application No. 62/237,712 filed Oct. 6, 2015 and entitled “System and Method for Conveying Entertainment or Social Events.” The complete text of this application is hereby incorporated by reference as though fully set forth herein in its entirety.

### FIELD OF THE INVENTION

The invention relates to various systems and methods for conveying information associated with one or more entertainment and/or social events to one or more potential participants and/or one or more places of business to one or more potential customers. In one embodiment, the present invention relates to a system and method that permits an individual user to find one or more desired entertainment and/or social events based on one or more criteria (e.g., location, date, geographical proximity, etc.). In another embodiment, the present invention permits one or more business users to advertise, interact and/or promote one or more entertainment and/or social events based, and/or their place of business to one or more individual users/customers.

### BACKGROUND OF THE INVENTION

Wireless communication networks are well known in the art and have been designed to deliver various content including, but not limited to, media content, advertising content, social content, etc. to recipients. For example, wireless communication networks may comprise a broadcast or multicast system, which transmit information to multiple recipients at the same time. In addition to delivering real-time dissemination and/or broadcastings of various content including, but not limited to, media content, advertising content, social content, etc. to recipients, these types of systems are especially suited for the delivery and presentation of advertising media content, otherwise referred to as advertisements or ads, to wireless communication devices, such as cellular telephones and the like. In addition to multicast and broadcast media distribution systems, other wireless device applications may be configured to receive and present advertising media content.

Success in the online advertising market has resulted in heightened interest in wireless or mobile advertising. Online advertising has shown that advertisers are more willing to pay a premium for improved advertising effectiveness. In this regard, online advertising has resulted in a payment model in which advertisers only pay for quantifiable advertising results.

Location is key differentiator of a mobile wireless networked device relative to a fixed device, such as personal computer or the like. Thus, while the fixed device primarily remains at one location, the wireless device may be located anywhere at any given point in time. Many of the currently available wireless devices are equipped with some form of location determination, such that the device or device in combination with the network can determine the current location of the wireless device. Such location determination is readily used in mapping applications, as well as many other applications that may be implemented on the wireless device. In this regard, the wireless device may be equipped with Global Positioning System (GPS) location determination capability, another satellite-based location determination capability or a network-based location determination capability, such as AFLT (Advanced Forward Link Trilateration) or the like.

Also of interest to business users is the ability to promote and/or market various entertainment and/or social events based on one or more criteria (e.g., location, date, geographical proximity, etc.), advertise and/or market a business user's one or more places of business, promote one or more specials, coupons or other events, etc. As to individual users, such users are interested in the ability to find one or more entertainment and/or social events based on one or more criteria (e.g., location; date; geographical proximity; specials and/or coupons offered; types of activities, foods and/or entertainment offered; etc.), connect with one or more friends over a social networked enabled application and/or make social plans with one or more friends over a social networked enabled application.

Therefore, a need exists for a system, method, apparatus and/or computer program product that provides business users the ability to promote and/or market various entertainment and/or social events based on one or more criteria (e.g., location, date, geographical proximity, etc.), advertise and/or market a business user's one or more places of business, promote one or more specials, coupons or other events, etc. via one or more wirelessly-enabled or cellularly-enabled devices. Additionally, there exists a need for a system, method, apparatus and/or computer program product that provides individual users the ability to find one or more entertainment and/or social events based on one or more criteria (e.g., location; date; geographical proximity; specials and/or coupons offered; types of activities, foods and/or entertainment offered; etc.), connect with one or more friends over a social networked enabled application and/or make social plans with one or more friends over a social networked enabled application via one or more wirelessly-enabled or cellularly-enabled devices.

### SUMMARY OF THE INVENTION

The invention relates to various systems and methods for conveying information associated with one or more entertainment and/or social events to one or more potential participants and/or one or more places of business to one or more potential customers. In one embodiment, the present invention relates to a system and method that permits an individual user to find one or more desired entertainment and/or social events based on one or more criteria (e.g., location, date, geographical proximity, etc.). In another embodiment, the present invention permits one or more business users to advertise, interact and/or promote one or more entertainment and/or social events based, and/or their place of business to one or more individual users/customers.

In one embodiment, the present invention relates to a computer-implemented method for wireless networking of individual users with one or more business users comprising the steps of: processing with one or more first wireless computing devices a program that generates one or more individual user geographical locations generated by the one or more first wireless computing devices so as to determine the geographical location of the one or more individual users; permitting the one or more individual users via processing to set a radius of expectation based on the geographical location of the one or more individual users; processing with one or more second computing devices a program that generates one or more business user locations generated by the one or more second computing devices so as to determine the location of the one or more business users; permitting the one or more business users via processing to set a radius of influence based on the geographical location of at least one business location of each of the one or more business users; and enabling the one or more business users to send one or more pieces of marketing related content to any one or more of the individual users whose radius of expectation overlaps an individual business user's radius of influence.

In another embodiment, the present invention relates to a computer-implemented method for wireless networking of individual users with one or more business users comprising the steps of: processing with one or more first location determining-enabled wireless computing devices a program that generates one or more individual user geographical locations generated by the one or more first location determining-enabled wireless computing devices so as to determine the geographical location of the one or more individual users; permitting the one or more individual users via processing to set a radius of expectation based on the geographical location of the one or more individual users; processing with one or more second location determining-enabled computing devices a program that generates one or more business user locations generated by the one or more second location determining-enabled computing devices so as to determine the location of the one or more business users; permitting the one or more business users via processing to set a radius of influence based on the geographical location of at least one business location of each of the one or more business users; and enabling the one or more individual users via processing to search for one or more social and/or entertainment events within each individual user's radius of expectation.

In still another embodiment, the present invention relates a computer-implemented method for wireless networking of a host individual user with one or more invited individual users comprising the steps of: processing with one or more first GPS-enabled wireless computing devices a program that generates one or more host individual user geographical locations generated by the one or more first GPS-enabled wireless computing devices so as to determine the geographical location of the one or more host individual users; processing with one or more second GPS-enabled computing devices a program that generates one or more invited individual user locations generated by the one or more second GPS-enabled computing devices so as to determine the location of the one or more invited individual users; enabling the one or more host individual users via processing to search for one or more social and/or entertainment events within a defined geographical radius from all located users; enabling the one or more host individual users via processing to invite the one or more invited individual users to at least one social and/or entertainment event; and enabling the one or more invited individual users via processing to accept or decline attendance at the at least one social and/or entertainment event.

### BRIEF DESCRIPTION OF THE DRAWINGS

FIG. 1 is an illustration of a wireless and/or cellular network having multiple users connected thereto for the purposes of enabling such individual and/or business users to access and utilize the system and method of the present invention;

FIG. 2 is a flow diagram illustrating an exemplary process that can be taken by an individual user upon opening the program and/or mobile application that forms the basis of the present invention;

FIG. 3 is a flow diagram illustrating an exemplary process that permits a user to select one or more trends;

FIG. 4 is a flow diagram illustrating an exemplary process that permits a user to select, control and/or modify one or more notifications that are generated by the system and method of the present invention;

FIG. 5 is a flow diagram illustrating an exemplary process that permits a user to select, control and/or modify one or more kept/stored searches for one or more entertainment and/or social events based on one or more criteria;

FIG. 6 is a flow diagram illustrating an exemplary process that permits a user to select, control and/or modify one or more kept/stored interests that can be utilized to facilitate searches for one or more entertainment and/or social events based on one or more criteria;

FIG. 7 is a flow diagram illustrating an exemplary process that permits an individual user to communicate with one or more business users and/or business profiles;

FIG. 8 is a flow diagram illustrating an exemplary process that permits an individual user to control, modify and/or update a calendar of one or more entertainment and/or social events generated from various aspects of the system and/or method of the present invention;

FIG. 9 is a flow diagram illustrating an exemplary process that permits a user to select, control and/or modify one or more kept/stored places, events and/or businesses;

FIGS. 10A and 10B together are a flow diagram illustrating an exemplary process that permits a user to select, search for, control and/or modify one or more kept/stored social and/or entertainment events/places;

FIG. 11 is a diagram representing the overlap between various business users' radii of influence and that of two exemplary individual users' radii of expectation (where “BU” stands for Business User);

FIGS. 12A and 12B together are a flow diagram illustrating an exemplary process that permits an individual user to select, control and/or modify one or more kept/stored specials and/or coupons related to one or more of a business user's place of business and/or one or more social and/or entertainment events/places;

FIGS. 13A and 13B together are a flow diagram illustrating an exemplary process that permits a business user to be notified that one or more individual users are in the business user's radius of influence;

FIG. 14 is a flow diagram illustrating an exemplary process that permits a business user to utilize, update and/or create a business profile;

FIG. 15 is a flow diagram illustrating an exemplary process that permits a business user to utilize, update and/or create one or more social and/or entertainment events;

FIG. 16 is a flow diagram illustrating an exemplary process that permits a business user to utilize, update and/or create one or more specials associated with the business user's one or more places of business and/or one or more specials that are associated with one or more social and/or entertainment events being put on and/or sponsored by the business user;

FIGS. 17A and 17B together are a flow diagram illustrating an exemplary process that permits a business user to utilize, update and/or create one or more coupons associated with the business user's one or more places of business and/or one or more coupons that are associated with one or more social and/or entertainment events being put on and/or sponsored by the business user;

FIG. 18 is a flow diagram illustrating an exemplary process that permits a business user to communicate via one or more of text, live chat, etc. with one or more individual users;

FIGS. 19A and 19B together are a flow diagram illustrating an exemplary process that permits a business user to utilize, update and/or create one or more blast notifications directed to one or more individual users relating to the business user's one or more places of business and/or relating to one or more social and/or entertainment events being put on and/or sponsored by the business user;

FIGS. 20A and 20B together are a flow diagram illustrating an exemplary process that permits an individual user to utilize, update and/or create one or more friend events directed to one or more friends in the individual user's social circle;

FIG. 21A is a flow diagram illustrating an exemplary process that permits an individual user to map one or more other individual users and to communicate via one or more of text, live chat, etc. with any one or more individual users that are checked-in/on-line;

FIG. 21B is a flow diagram illustrating an exemplary process that permits an individual user to map one or more other business users/business profiles and to communicate via one or more of text, live chat, etc. with any one or more business users/business profiles that are checked-in/on-line;

FIG. 22 is a flow diagram illustrating an exemplary process that permits an individual user to keep/store one or more individual user and/or business user/business profile and to communicate via one or more of text, live chat, etc. with any one or more of such individual users and/or business users/business profiles that are checked-in/on-line;

FIGS. 23A and 23B together are a flow diagram illustrating an exemplary process that permits an individual user to create kept/stored individual user and/or business user lists from those individual users and/or business users that are within a selected radius of expectation and to communicate via one or more of text, live chat, etc. with any one or more of such individual users and/or business users/business profiles that are checked-in/on-line;

FIG. 24 is a block diagram of one exemplary operating environment or systems capable of implementing one or more systems, apparatuses, or processes of the present invention; and

FIG. 25 is a block diagram of another exemplary operating environment or systems capable of implementing one or more systems, apparatuses, or processes of the present invention.

### DETAILED DESCRIPTION OF THE INVENTION

The invention relates to various systems and methods for conveying information associated with one or more entertainment and/or social events to one or more potential participants and/or one or more places of business to one or more potential customers. In one embodiment, the present invention relates to a system and method that permits an individual user to find one or more desired entertainment and/or social events based on one or more criteria (e.g., location, date, geographical proximity, etc.). In another embodiment, the present invention permits one or more business users to advertise, interact and/or promote one or more entertainment and/or social events based, and/or their place of business to one or more individual users/customers.

While not limited thereto, the present invention provides, at a minimum, the following, a system, method, apparatus and/or computer program product that provides to one or more business users the ability to promote and/or market various entertainment and/or social events based on one or more criteria (e.g., location, date, geographical proximity, etc.), advertise and/or market the business user's one or more places of business, promote one or more specials, coupons or other events, etc. via one or more wirelessly-enabled or cellularly-enabled devices. Additionally, the present invention provides, at a minimum, the following, a system, method, apparatus and/or computer program product that provides one or more individual users the ability to find one or more entertainment and/or social events based on one or more criteria (e.g., location; date; geographical proximity; specials and/or coupons offered; types of activities, foods and/or entertainment offered; etc.), connect with one or more friends over a social networked enabled application and/or make social plans with one or more friends over a social networked enabled application via one or more wirelessly-enabled or cellularly-enabled devices.

Initially, it should be noted that although the present invention is described with regard to a number of block diagrams and/or flow diagrams, the present invention is not limited solely to the components and/or process steps illustrated in these diagrams. Rather, as would be apparent to those of skill in the art upon reading and understanding the nature of the present invention, various components and/or one or more process steps could be eliminated, completed in different orders and/or rearranged and/or combined with other processes and/or steps of the present invention. Additionally, although the block diagrams and/or flow diagrams are presented herein in a certain order, the order of these diagrams is of no importance as a user accessing the system and method of the present invention could access any of the process components thereof in any desired order.

Regarding the present invention, the present invention involves the use of a program, mobile application, computer application and/or code-based application to enable one or more individual users to find one or more entertainment and/or social events based on one or more criteria (e.g., location; date; geographical proximity; specials and/or coupons offered; types of activities, foods and/or entertainment offered; etc.), connect with one or more friends over a social networked enabled application and/or make social plans with one or more friends over a social networked enabled application via one or more wirelessly-enabled or cellularly-enabled devices. Additionally, the present invention also simultaneously permits one or more business users to promote and/or market various entertainment and/or social events based on one or more criteria (e.g., location, date, geographical proximity, etc.), advertise and/or market the business user's one or more places of business, promote one or more specials, coupons or other events, etc. via one or more wirelessly-enabled or cellularly-enabled devices. Given this, the present invention facilitates, permits and/or enables individual users and business users to communicate regarding one or more entertainment and/or social events and/or one or more marketing promotions relating to one or more business user's places of business through various platforms. Additionally, the present invention permits one individual user to plan, create and invite other individual users to one or more entertainment and/or social events.

Additionally, when the discussion herein turns to the input of various information, search criteria and/or other needed inputs it should be noted that such inputs can be accomplished by touch screen keyboards, regular keyboards, saved criteria and/or voice inputs.

Furthermore, while the invention herein is primarily described in relation to one or more social and/or entertainment events, it should be noted that the present invention is not limited solely to just these types of events. As would be apparent to those of skill in the art upon reading and understanding the present invention as it is described below, the present invention can be utilized to connect various users/event goers/customers with any type of social event/entertainment event/place of business. As such, the nature of the present invention should be broadly construed even though every possible use of the system, method and/or program of the present invention are not each discussed in detail.

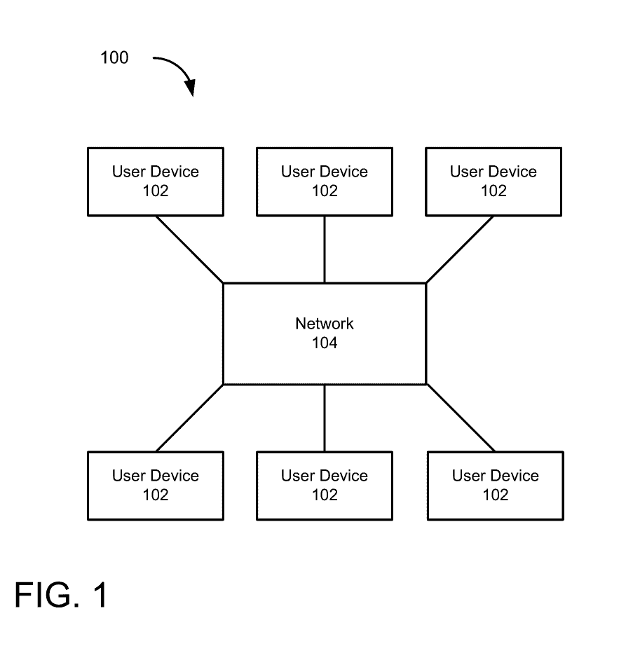

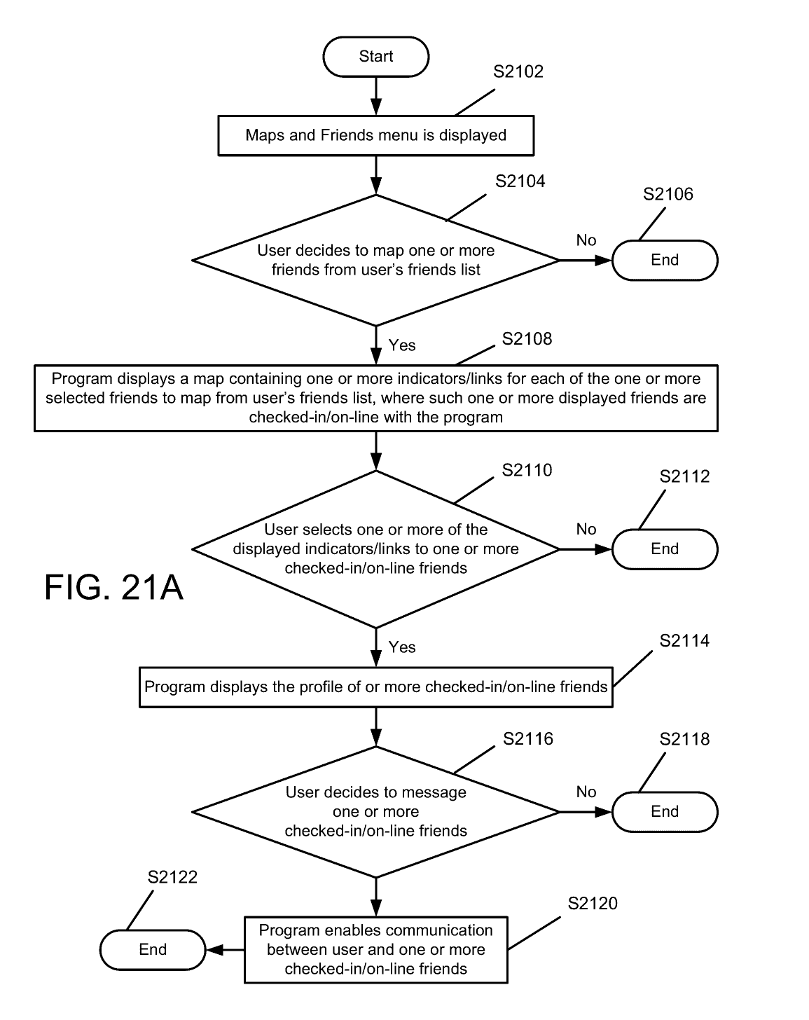

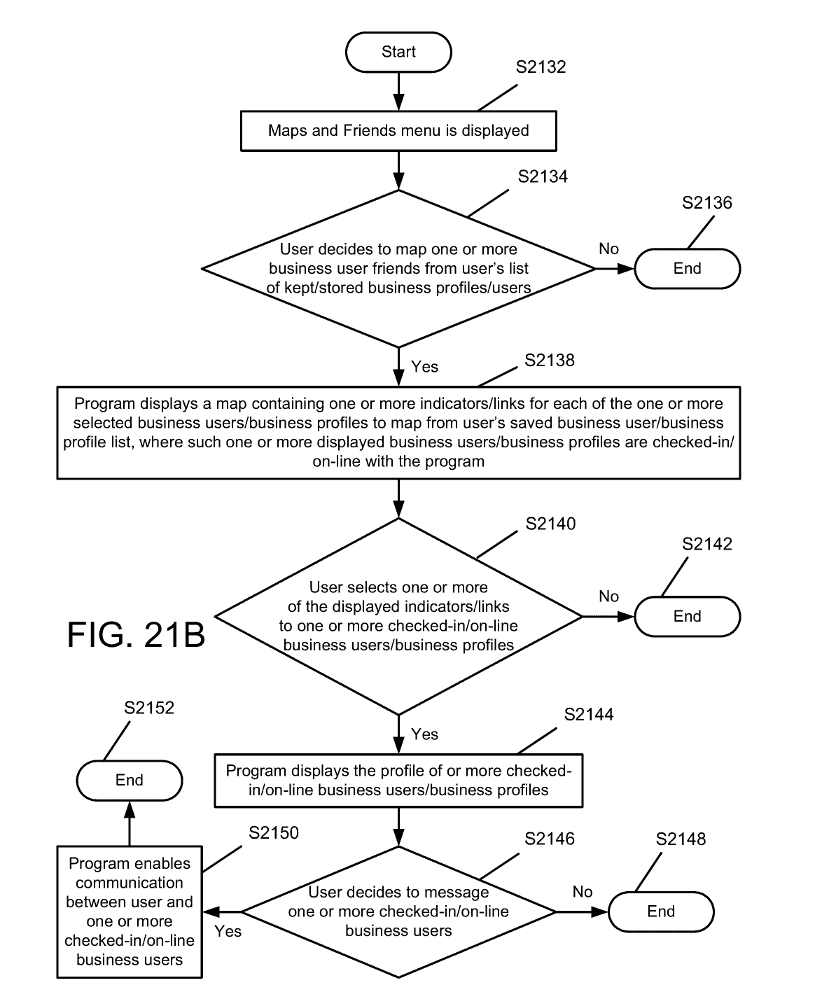

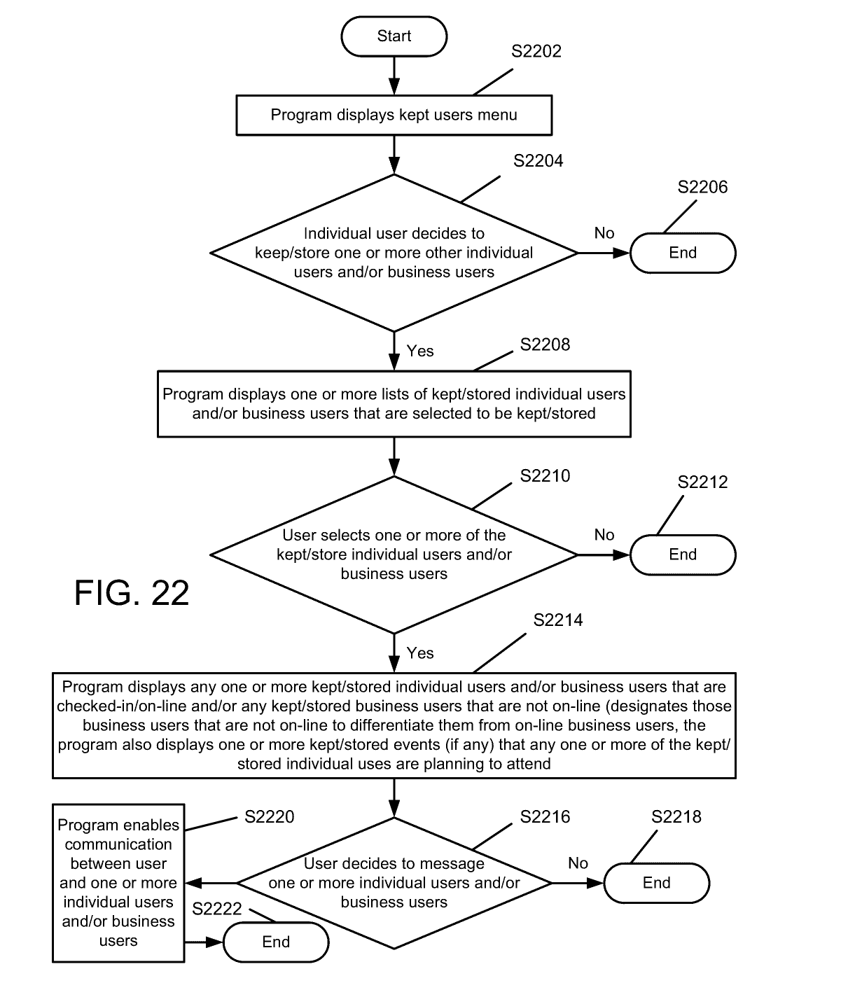

Turning to FIG. 1, FIG. 1 represents a basic block diagram of a mobile computing network 100 having a plurality of user devices 102 connected to a network 104. As will be explained in more detail below with regard to FIGS. 21 and 22, network 104 of the present invention can be, without limitation, any type of cellular network, wireless network, or other cloud-based network that permits one or more user mobile devices 102 to connect thereto and communicate therewith including user-to-user communication between mobile user devices. With regard to the nature of user devices 102, such devices include, but are not limited to, smart phones, tablets, phablets, cell phones, wirelessly-enabled computing devices, cellularly-enabled computing devices, location-determining-enabled device (e.g., GPS-enabled device, geo-location device, etc.), etc.

It is noted that, terms “user equipment,” “device,” “user equipment device,” “client,” and the like are utilized interchangeably in the subject application, unless context warrants particular distinction(s) among the terms. Such terms may refer to a network component(s) or appliance(s) that sends or receives data, video, sound, or substantially any data-stream or signaling-stream to or from network components and/or other devices. By way of example, a user equipment device may comprise an electronic device capable of wirelessly sending and receiving data. A user equipment device may have a processor, a memory, a transceiver, an input, and an output. Examples of such devices include cellular telephones (e.g., smart phones), personal digital assistants (PDAs), portable computers (e.g., laptop computers), tablet computers (tablets), hand-held gaming counsels, wearables (e.g., smart watches), etc.

Furthermore, the terms “user,” “customer,” “consumer,” and the like are employed interchangeably throughout the subject specification, unless context suggests otherwise or warrants a particular distinction among the terms. In another aspect, terms such as “business user,” “administrator,” “provider” and the like are employed interchangeably throughout the subject specification, unless context suggests otherwise or warrants a particular distinction among the terms. It is noted that such terms may refer to human entities or automated components supported through artificial intelligence (e.g., a capacity to make inference).

While embodiments described herein may refer to a process, program, and/or computer implemented process, it is noted that aspects disclosed herein may be implemented via one or more systems. For instance, a system may include computer-executable modules that may be stored in a memory and/or may be executed by a computer processor. In an example, a system may comprise modules implemented via one or more of the user devices 102 and/or devices of the network 104 (e.g., servers, data stores, etc.). Furthermore, while examples may describe a user action, it is appreciated that a user may or may not be required to provide input and/or preform actions. In an aspect, references to a user “providing an indication,” “indicating,” “deciding,” or the like, may represent a device receiving input from a user. For sake of brevity, examples are described with reference to user actions, however, it is noted that the user may not be required to perform actions and/or various processes and systems of the present invention need not require such user action.

Furthermore, examples may reference one or more particular types of marketing related content, such as coupons, invitations, advertisements, or the like. It is noted that embodiments may utilize any type of marketing related content unless context suggests otherwise or warrants a particular distinction. Generally, the marketing related content may comprise audio, visual, and/or tactile content. For instance, the content may include at least one of an image, a video, audio, a vibration (e.g., vibration generated by a user device), or the like.

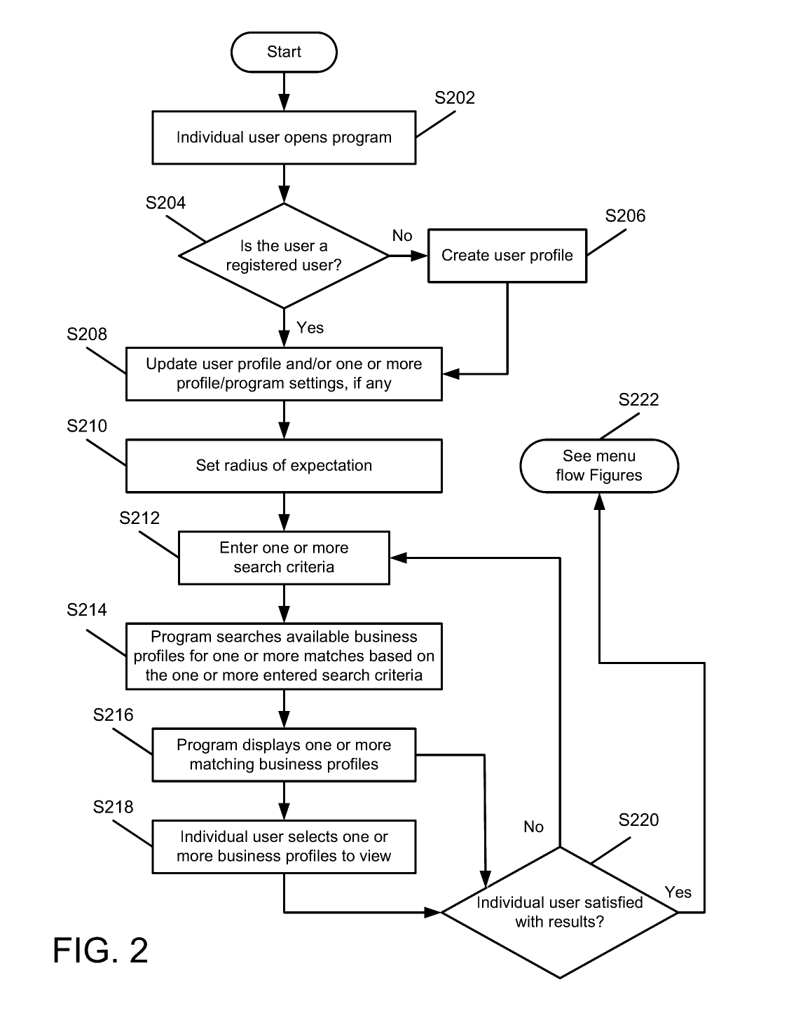

Turning to FIG. 2, FIG. 2 is a flow diagram illustrating an exemplary process that can be taken by an individual user upon opening the program and/or mobile application (hereinafter referred to collectively as “program”) that forms the basis of the present invention. In an aspect, a computer-readable memory may store computer-executable instructions that cause a processor to execute acts/actions. These actions may facilitate execution of the program. While processes, here as well as elsewhere, are shown and described as a series of blocks, it is noted that associated processes are not limited by the order of the blocks. It is further noted that some blocks and corresponding actions may occur in different orders or concurrently with other blocks. Moreover, different blocks or actions may be utilized to implement the processes described hereinafter. Various actions may be completed by one or more of users, devices (e.g., including one or more processors or computing devices), or the like. With regard to FIG. 2 specifically, once an individual user starts by opening the program of the present invention at S202 the program queries the individual user as to whether they have previously registered as a registered individual user at S204. If the individual user answers “no” they are taken to S206 and prompted to create an individual use profile. If the individual user answers “yes” they are taken to S208 and prompted as to whether or not the individual user would like to update one or more pieces of information relating to their user profile. Upon creating and/or updating one's profile the program of the present invention permits an individual user to specify user data (e.g., any one or more of their age, sex, date of birth, year of birth, location, ethnicity, user name, email, password, etc.), links to one or more social media services (e.g., Facebook, Twitter, LinkedIn, etc.), upload and/or edit a profile image or personal image, choose to remain logged-in or logged-out after the program is closed, etc.

Next at S210 the individual user is prompted to set their radius of expectation. As utilized herein, “radius of expectation” is a geographical filtering parameter that can be set and/or changed by an individual user (or may be altered via another process), so as to filter search results relating to one or more entertainment and/or social events and/or one or more marketing promotions offered by one or more business users. It should be noted that any individual user's radius of expectation (e.g., the area in which the program searches for active items to display to the individual user) can be set based on one or more of a desired distance radius (e.g., a 5 mile radius, a 10 mile radius, a 25 mile radius, etc.) from the location generated by a GPS-enabled mobile device; a zip code; a city, county or some other municipal designation; or any other suitable geographical designation. While examples may refer to a GPS-enabled mobile device, it is noted that a location may be received based on other methodologies and/or systems. For example, a location of a device may be determined based on a device access a network (e.g., a Wi-Fi network of a retail store), user input (e.g., a user identifying a location of their device), in-store or location based transactions (e.g., mobile application purchases while in a store, such as Bitcoin), or other methods for determining a user location (e.g., a user scanning a Quick Response Code (“QRC”) at a physical location), or the like. Furthermore, while embodiments describe a “radius” it is noted that the program may utilize other measurements or means. In an example, the program may utilize a number of city blocks, a neighborhood (e.g., uptown, downtown, midtown, etc.). Moreover, a “radius” does not necessarily require a circular area. Radius is utilized for simplicity or explanation. Accordingly, other units or measurement and/or classifying distances/areas are considered within the scope and spirit of this disclosure.

Next at S212 the individual user enters one or more search criteria including, but not limited to, location (which may or may not be based on the individual user's radius of influence); event type; food type; the availability of one or more coupons and/or specials; the type and/or amount of one or more available coupons; one or more calendar dates; business and/or event name (including partial names) and/or availability of certain foods and/or beverages to search for one or more entertainment and/or social events, one or more business users and/or one or more marketing promotions offered by one or more business users into the program causing the program to generate a search results list containing one or more entertainment and/or social events, one or more business users and/or one or more marketing promotions offered by one or more business users at S214. Next at S216 the program displays the results of such a search and prompts the individual user to select at S218 one or more business profiles, event results and/or marketing results to view based on the previously entered search criteria. If, as is shown at S220, the individual user is satisfied with the search results the user can proceed to other aspects of the program as detailed in the other various Figures described herein. If not, the individual user is returned to S212 to revise the one or more entered search criteria so as to generate a different (e.g., better) set of search results.

It should be noted that if the user is already a registered individual user, such an individual user may or may not see registration notification S204 generated upon start-up by the application. It should also be noted that at any time desired an individual user can access the portion of the program that permits such an individual user to update their profile.

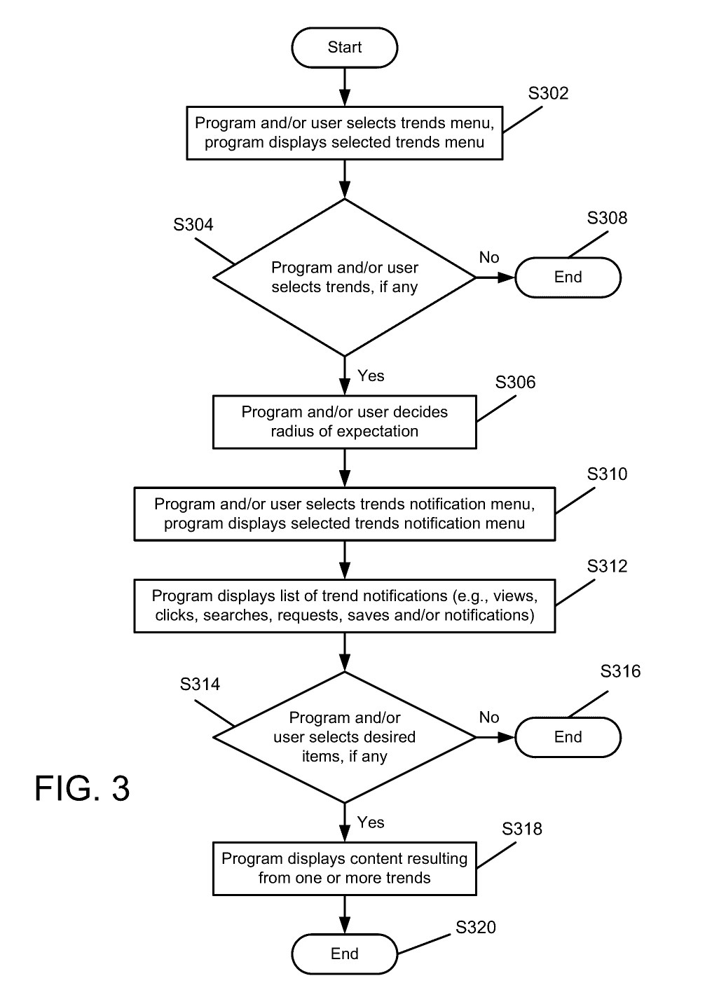

Turning to FIG. 3, FIG. 3 is a flow diagram illustrating an exemplary process that permits a user to select one or more trends. As shown in FIG. 3, this portion of the program starts when a user (generally an individual user but not necessarily), opens a trends menu in the program at S302. Next, the program prompts the user to select one or more trends at S304. If the user decides at S304 to select one or more trends including, but not limited to, user clicks, search requests, search result hits, kept/saved individual user notification requests, and/or kept/saved individual user business profiles. If the user decides to forego selecting one or more trends this portion of the program ends as is shown at S308. At S306, this portion of the program prompts the user to either utilize their previously entered and/or determined radius of expectation or to enter a new and/or updated radius of expectation.

Next at S310 the user is either prompted to open, or the program automatically opens, the trends notification menu based on the previous, new and/or updated radius of expectation from S306. After opening this menu, the program at S312 displays a list of trend notifications including, but not limited to, user clicks, search requests, search result hits, kept/saved individual user notification requests, and/or kept/saved individual user business profiles. Next, at S314 the program prompts the user to select one or more of the displayed trends from the displayed list. If the user chooses not to select any trends this portion of the program ends at S316. If the user selects one or more trends, the program displays at S318 the content generated from such trends including, but not limited to, related business profiles, related social and/or entertainment events and/or related coupons and/or specials. Thereafter, this portion of the program ends at S320.

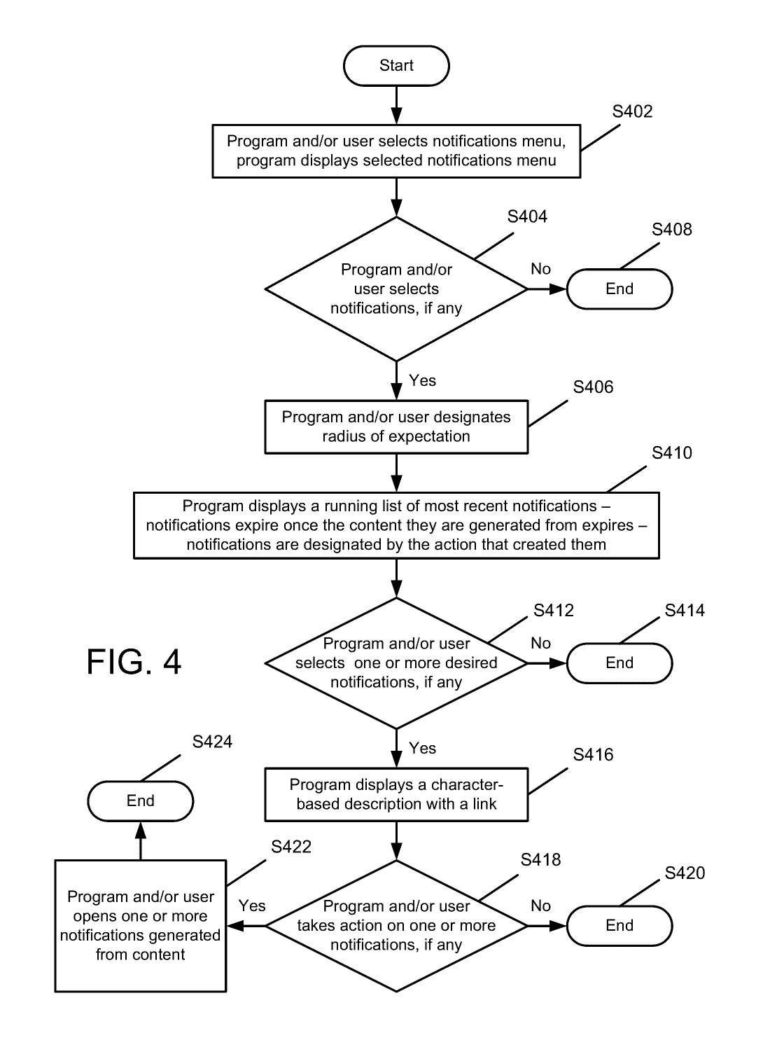

Turning to FIG. 4, FIG. 4 is a flow diagram illustrating an exemplary process that permits a user to select, control and/or modify one or more notifications that are generated by the system and method of the present invention. Regarding the present invention's ability to select, control and/or modify one or more notifications, this portion of the present invention is detailed starting at S402 where a user selects the notification menu and the program displays this menu. Next, at S404, either the user manually selects, or the program automatically selects, one or more notifications to be updated, deleted and/or otherwise modified. Notifications that can be kept include, but are not limited to, business-related coupons, any event at and/or put on by a predetermined business, any type of event regardless of the business putting on same and/or any saved/kept profiles that the user's one or more friends have decided to keep/save. If this is the case the program proceeds to prompt the user at S406 to either utilize their previously entered and/or determined radius of expectation or to enter a new and/or updated radius of expectation. If the user decides not to select any notifications, this portion of the program ends as is shown at S408.

Next, at S410, the program displays a running list of most recent notifications—notifications expire once the content they are generated from expires based on the previous, new and/or updated radius of expectation from S406. Then at S412 the program prompts and/or permits the user to select one or more notifications from the list of most recent notifications generated in S410. If the user fails to select any of the most recent notifications, this portion of the program ends at S414. If the user does in fact select one or more of the most recent notification from the list generated in S410, the program displays a character-based description of such one or more notifications at S416. The character-based description can include any number of characters but preferably contains no more than 140 characters to facilitate to electronic dissemination of such a description similar to text messages and permits the user to take action on such one or more notifications at S418. If the user fails to take action on any of the notification materials generated in S416, this portion of the program ends at S420. If the user does in fact take action on one or more of the notification materials generated in S416 the program opens such notification materials at S422. Thereafter, this portion of the program ends at S424.

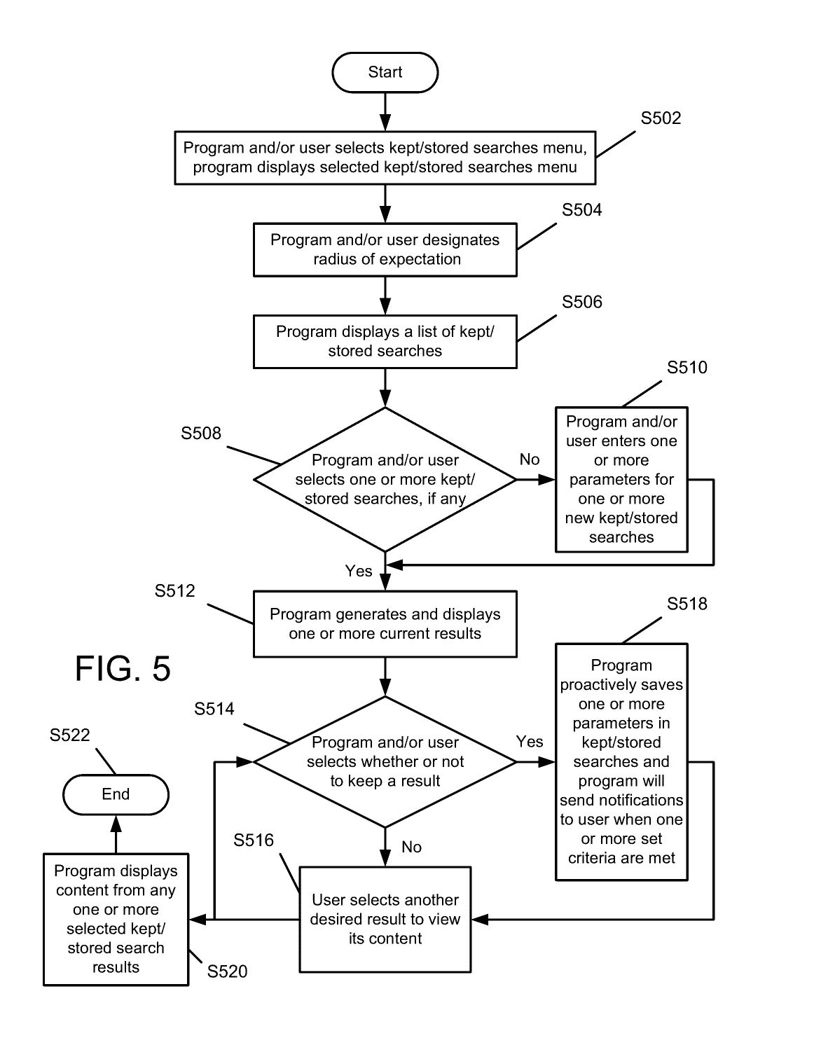

Turning to FIG. 5, FIG. 5 is a flow diagram illustrating an exemplary process that permits a user to select, control and/or modify one or more kept/stored searches for one or more entertainment and/or social events based on one or more criteria. As shown at S502 the user selects the kept/stored searches menu and the program displays this menu. Next, at S504, the program proceeds to prompt the user to either utilize their previously entered and/or determined radius of expectation or to enter a new and/or updated radius of expectation. Thereafter, at S506, the program displays a list of kept/stored searches based on the previous, new and/or updated radius of expectation from S504 whereby the user is prompted at S508 to select one or more of the kept/stored searches from the list so generated. If the user fails to select one or more of the kept/stored searches from the list generated in S506, the user is prompted to enter one or more new criteria and/or parameters in order to generate one or more new kept/stored searches at S510. If the user does select one or more of the kept/stored searches from the list generated in S506, the program displays a list of the one or more selected kept/stored searches at S512. This is also the results from S510 where the user enters one or more new criteria and/or parameters in order to generate one or more new kept/stored searches at S510. Thereafter, at S514, the program permits and/or prompts the user as to whether the user desires to keep each of the one or more kept/stored searches in the list generated in S512. At S516, if the user fails to keep one or more of the kept/stored searches from the list generated in S512 the user is prompted to select another kept/stored search from the list generated in S512. If no further entries are available this portion of the program skips ahead to S522 and ends. If the user does decide to keep one or more of the kept/stored searches from the list generated in S512, the program proactively saves, at S518, one or more parameters in kept/stored searches and will send notifications to user when one or more sets of criteria are met. This procedure repeats itself via S516 until the user has dealt with all of the kept/stored searches from the list generated in S512. Next, at S520, the program displays the content from any one or more of the kept/stored search results. Such content includes, but is not limited to, coupons, specials, menus, pictures, upcoming events, etc.

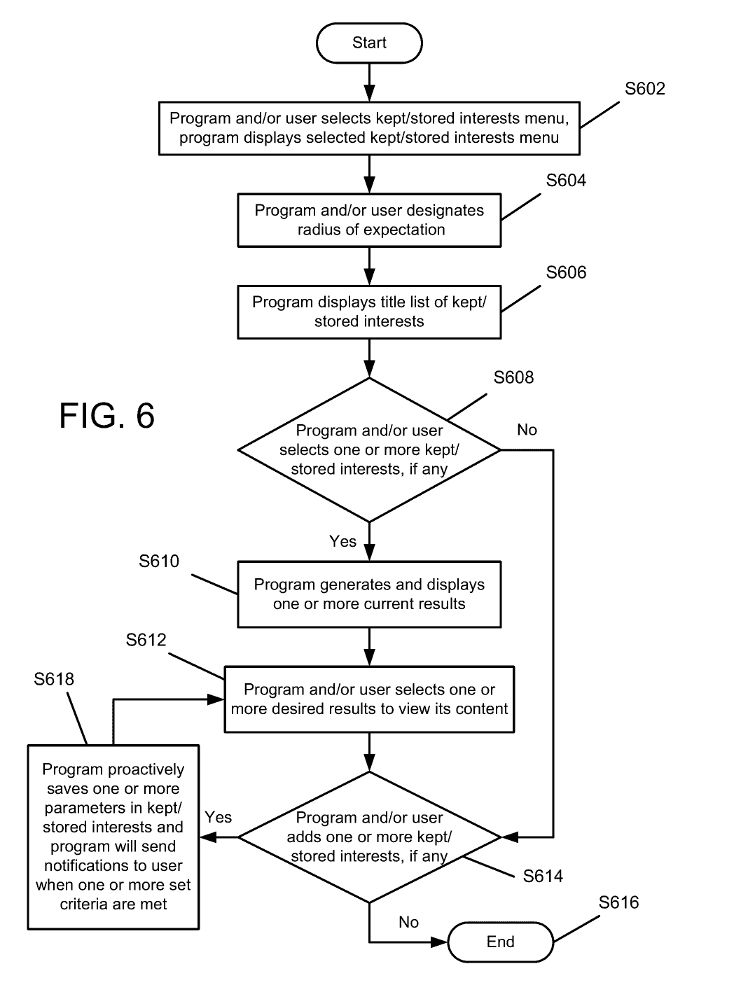

Turning to FIG. 6, FIG. 6 is a flow diagram illustrating an exemplary process that permits a user to select, control and/or modify one or more kept/stored interests that can be utilized to facilitate searches for one or more entertainment and/or social events based on one or more criteria. As shown at S602 the user selects the kept/stored interests menu and the program displays this menu. Next, at S604, the program proceeds to prompt the user to either utilize their previously entered and/or determined radius of expectation or to enter a new and/or updated radius of expectation. Thereafter, at S606, the program displays a list of kept/stored interests based on the previous, new and/or updated radius of expectation from S604 whereby the user is prompted at S608 to select one or more of the kept/stored interests from the list so generated. If the user does select one or more of the kept/stored interests from the list generated in S606, the program displays a list of the one or more selected kept/stored interests at S610. Thereafter, at S612, the program permits and/or prompts the user as to whether the user desires to keep each of the one or more kept/stored interests in the list generated in S610. If the user fails to keep one or more of the kept/stored interests from the list generated in S610, the user is prompted to add one or more kept/stored interests in S614. If the user fails to select one or more of the kept/stored interests from the list generated in S606, the user is prompted to enter/add one or more kept/stored interests in S614. If the user does not enter any new kept/stored interests the process ends at S616. If the user does decide to enter one or more new kept/stored interests the program proactively saves, at S618, one or more parameters in kept/stored interests and program will send notifications to user when one or more set criteria are met. This procedure repeats itself via S612, S614 and S618 until the user has dealt with all of the kept/stored interests that they so desire to set-up and/or add.

Regarding the criteria available for such one or more kept/stored interests they include, but are not limited to, location; date; geographical proximity to the user's radius of expectation; specials and/or coupons offered; types of activities, foods and/or entertainment offered; etc.

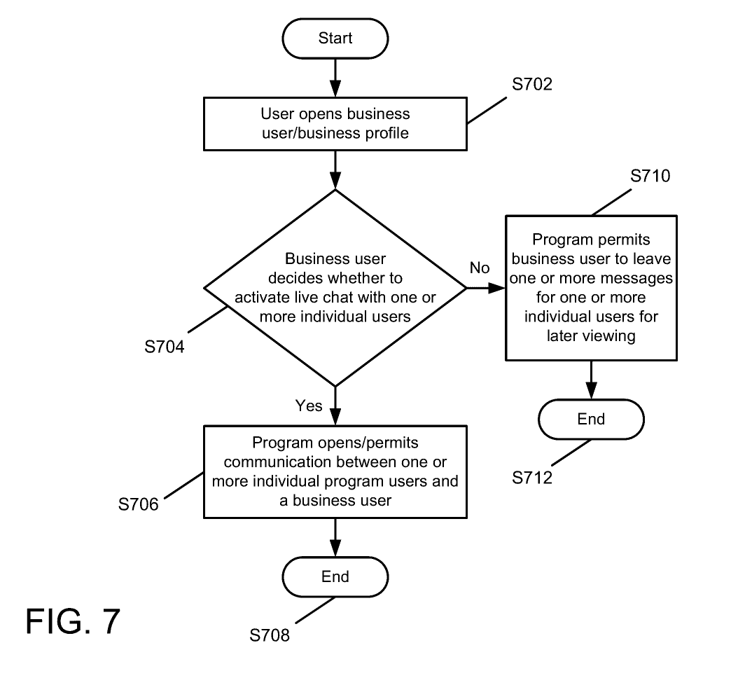

Turning to FIG. 7, FIG. 7 is a flow diagram illustrating an exemplary process that permits an individual user to communicate with one or more business users and/or business profiles. As is illustrated in FIG. 7, this portion of the program begins with an individual user, or even the program itself, opening one or more business users and/or business profiles at S702. In response to this the program sends a notification to the business user that an individual user has viewed their business profiled and/or business user profile. If the business user is available and/or near a connected device, the business user can decide to, at S704, activate live chat with such one or more individual users that have opened the business user's profile at S702. If the business user decides to activate the live chat, the program, at S706, opens/permits communication between such one or more individual users and the business user. After communication is complete this portion of the program ends at S708. If the business user declines to activate the live chat, the program, at S710, permits the business user to leave one or more messages for such one or more individual users for later viewing. After communication is complete this portion of the program ends at S712. In at least one embodiment, an individual user can activate a live chat. It is noted that a business user may enable/disable this aspect.

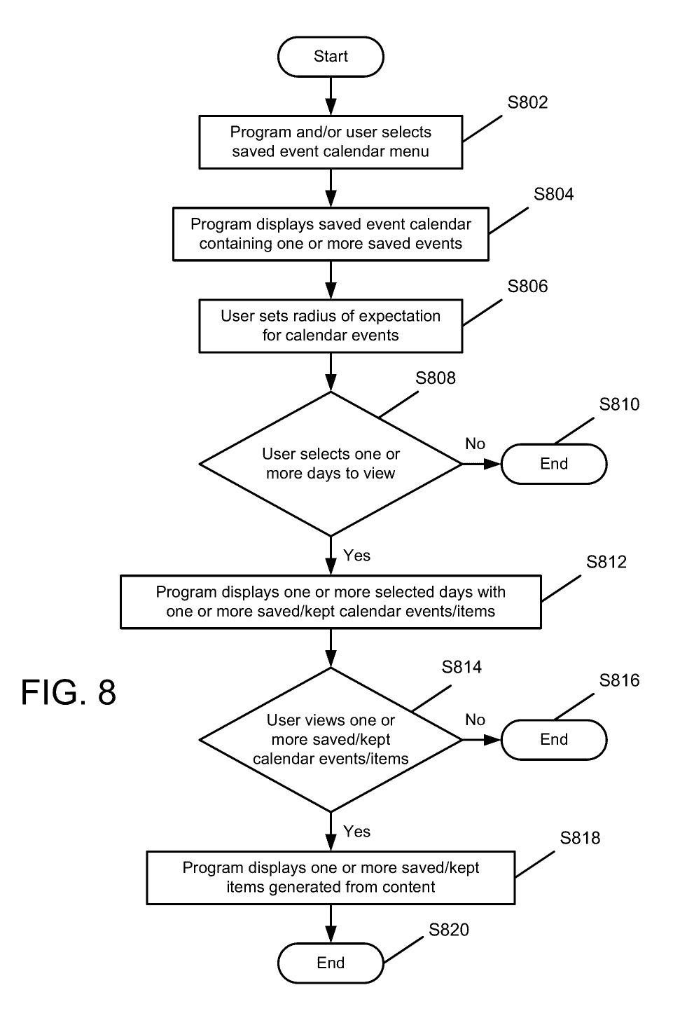

Turning to FIG. 8, FIG. 8 is a flow diagram illustrating an exemplary process that permits an individual user to control, modify and/or update a calendar of one or more entertainment and/or social events generated from various aspects of the system and/or method of the present invention. As is illustrated in FIG. 8, this portion of the program begins with an individual user, or even the program itself, opening the saved event calendar menu at S802. Next, at S804, the program proceeds to display a saved event calendar containing one or more saved events. Next, at S806, the program proceeds to prompt the user to either utilize their previously entered and/or determined radius of expectation or to enter a new and/or updated radius of expectation. Thereafter, the user selects one or more days on the displayed event calendar to view at S808. If the user fails to select at least one day to display, this portion of the program ends at S810. If the user does indeed select one or more days to display, the program displays the one or more selected event calendar days with one or more saved/kept calendar events thereon at S812.

Next, at S814, the program prompts the user to select one or more of the saved kept calendar events to view. If the user fails to do so, this portion of the program ends at S816. If the user does indeed select one or more of the saved kept calendar events to view the program, at S818, displays one or more of the saved/kept items generated from content. Thereafter, this portion of the program ends, at S820, once the user has viewed all of the desired saved kept calendar events.

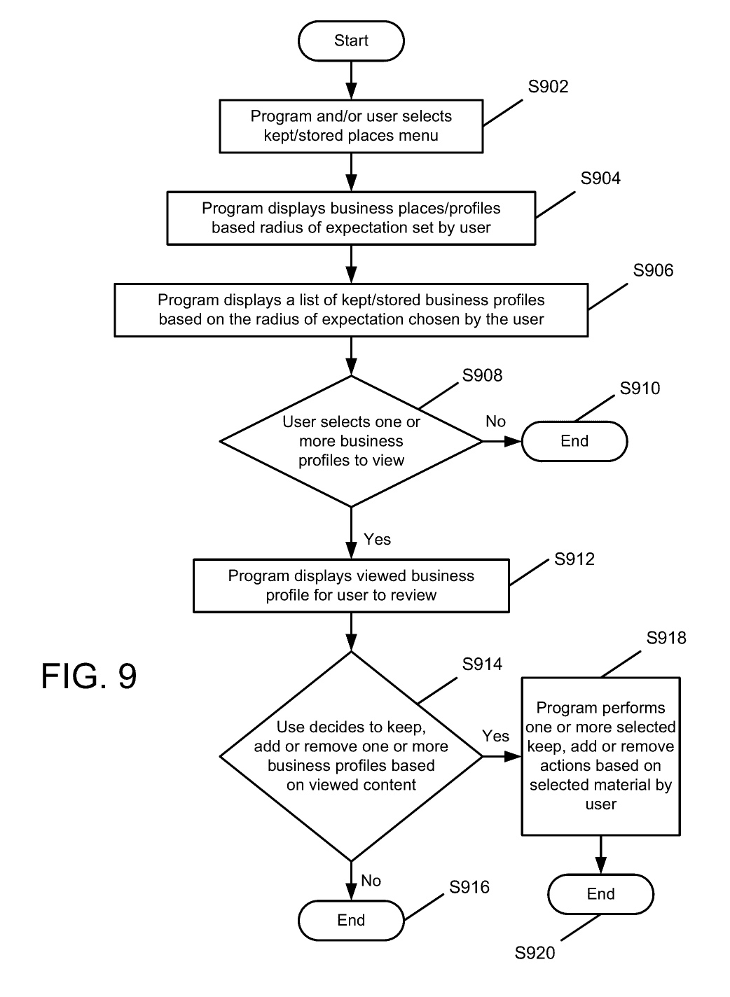

Turning to FIG. 9, FIG. 9 is a flow diagram illustrating an exemplary process that permits a user to select, control and/or modify one or more kept/stored places, events and/or businesses. As shown at S902 the user selects the kept/stored places menu and the program displays this menu. Next, at S904, the program proceeds to prompt the user to either utilize their previously entered and/or determined radius of expectation or to enter a new and/or updated radius of expectation. Thereafter, at S906, the program displays a list of kept/stored places and/or business profiles based on the previous, new and/or updated radius of expectation from S904. If the user fails to select one, at S908, or more of the kept/stored places from the list generated in S906, this portion of the program ends at S910. If the user does select, at S908, one or more of the kept/stored places from the list generated in S906, the program displays a list or profiles of the one or more selected kept/stored places at S912. Thereafter, at S914, the program permits and/or prompts the user as to whether the user desires to keep, modify, delete and/or add one or more kept/stored places in the list generated in S912. If the user fails to keep, modify and/or delete one or more of the kept/stored places from the list generated in S912 this portion of the program ends at S916. If the user does decide to keep, modify, delete and/or one or more of the kept/stored places from the list generated in S912, the program performs the appropriate functions at S918. This procedure repeats itself via S914 and 1918 until the user has complete all of the desired keep, modify, delete and/or add actions to the list generated in S912. Thereafter, this portion of the program ends at S920.

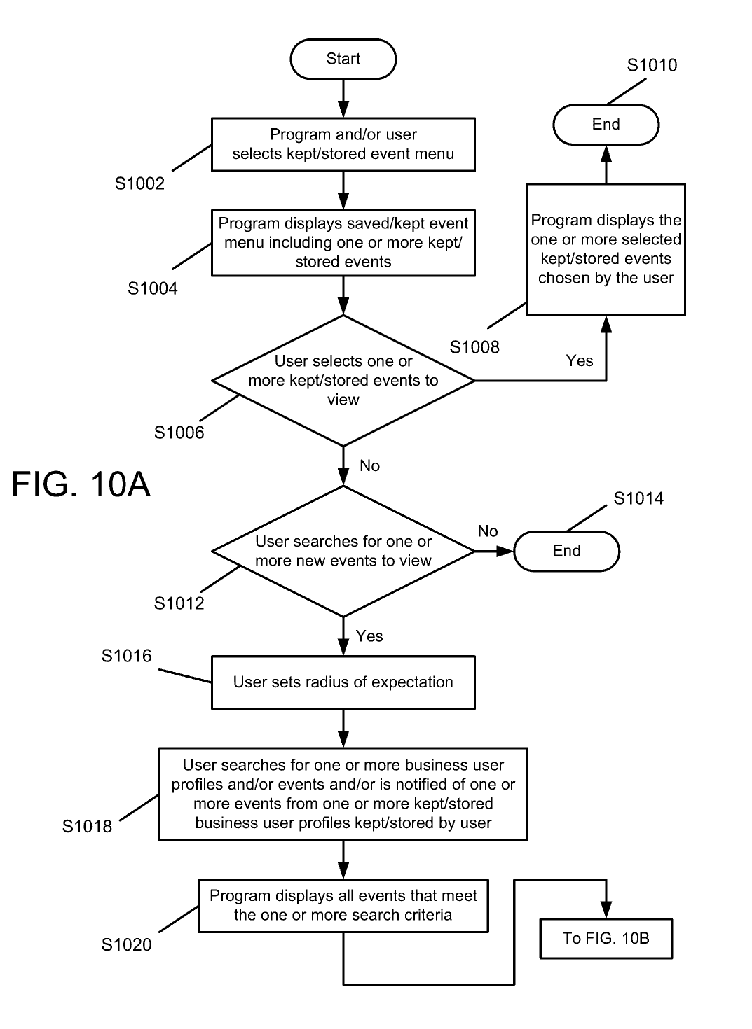

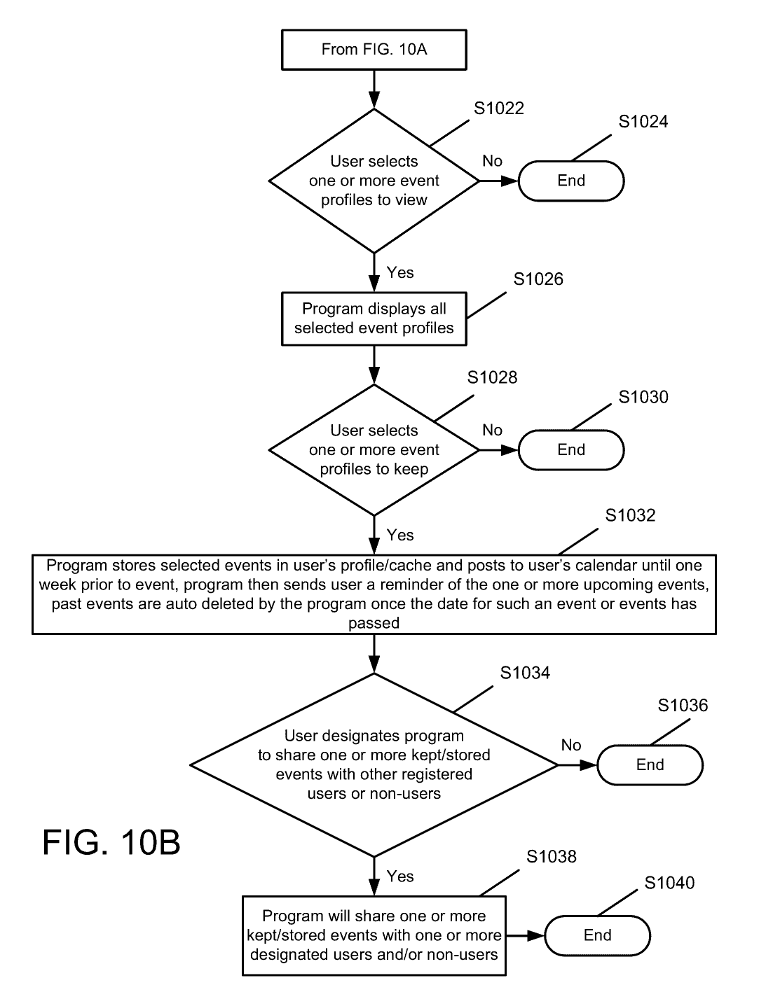

Turning to FIGS. 10A and 10B, FIGS. 10A and 10B, together, are a flow diagram illustrating an exemplary process that permits a user to select, search for, control and/or modify one or more kept/stored social and/or entertainment events/places. In S1002 the user selects the kept/stored events menu and the program displays this menu. Next in S1004 the program displays a list of kept/stored events and then in S1006 the user is prompted to select one or more kept/stored events to view. If the user does view one or more kept/stored events, the program then displays in S1008 the one or more selected kept/stored events chosen by the user. After all of these items have been viewed this portion of the program ends at S1010.

On the other hand, if the user declines to view one or more kept/stored events, the program then proceeds to S1012 to prompt the user to provide input as to whether the user wishes to search for one or more new events to view and/or may permit the user to provide input regarding such. As used with regard to FIGS. 10A and 10B, the word “event” is to be broadly construed in light of the disclosure contained herein with regard to the one or more social and/or entertainment events detailed above. If the user declines, this portion of the program ends at S1014. If the user does decide to search for one or more new events to view, the program proceeds to prompt the user, at S1016, to either utilize their previously entered and/or determined radius of expectation or to enter a new and/or updated radius of expectation. Thereafter, at S1018, the program permits and/or enables the user to search for one or more business users, business profiles and/or events that fall within their radius of expectation based one at least the business user's and/or the event's radius of influence. The program then at S1020 displays a list all the business users, business profiles and/or events that, at a minimum, meet the user's radius of expectation. Next, at S1022, the program queries the individual user as to whether the user wants to select one or more event profiles to view. If the user decides not to, this portion of the program ends at S1024. If the user decides to view one or more event profiles, the program displays all such selected event profiles at S1026.

It should be noted that a business user's radius of influence (the area the program utilizes as one non-limiting factor, or search criteria, when asked by an individual user to display one or more business profiles) can be set based on one or more of a desired distance radius (e.g., a 5 mile radius, a 10 mile radius, a 25 mile radius, etc.) from the location generated by a GPS-enabled mobile device; a zip code; a city, county or some other municipal designation; or any other suitable geographical designation.

Next, at S1028, the program queries the individual user as to whether the user wants to keep/store one or more viewed event profiles. If the user decides not to, this portion of the program ends at S1030. If the user decides to keep/store one or more viewed event profiles, the program stores, at S1032, selected event(s) in user's profile/cache and/or posts to user's calendar until one week prior to even. The program then sends the user a reminder of the one or more upcoming events. The program may automatically (e.g., without user intervention) delete past events once the date for such an event or events has passed. Thereafter, at S1034, the program queries the user as to whether or not the user would like to share one or more kept/stored events with other registered users or non-users. If the user decides not to, this portion of the program ends at S1036. If the user decides to share one or more kept/stored events profiles, the program shares, at S1038, such one or more event profiles with the one or more designated users and/or non-users selected. Thereafter, this portion of the program ends at S1040.

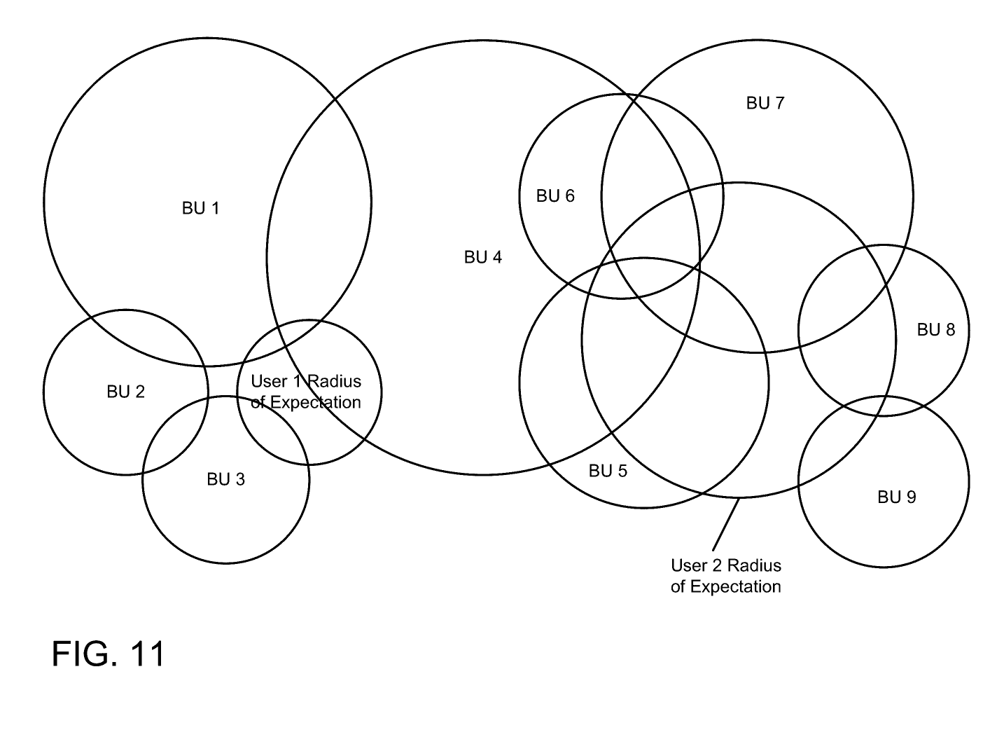

Turning to FIG. 11, FIG. 11 is a diagram representing the overlap between various business users' radii of influence and that of two exemplary individual users' radii of expectation. As can be seen in FIG. 11, business users (BU) 1 through 9 all have different radii of influence as represented by the circles relating to each in FIG. 11. Conversely, individual users 1 and 2 each have their own radius of expectation based on their present location, their home location, their work location, or any other pertinent location. As can be seen from FIG. 11, when an individual user's radius of expectation overlaps with at least one business user's radius of influence, the present invention permits the one or more functionalities described herein and/or with reference to one or more of FIGS. 2 through 10B and 12A through 20B to occur.

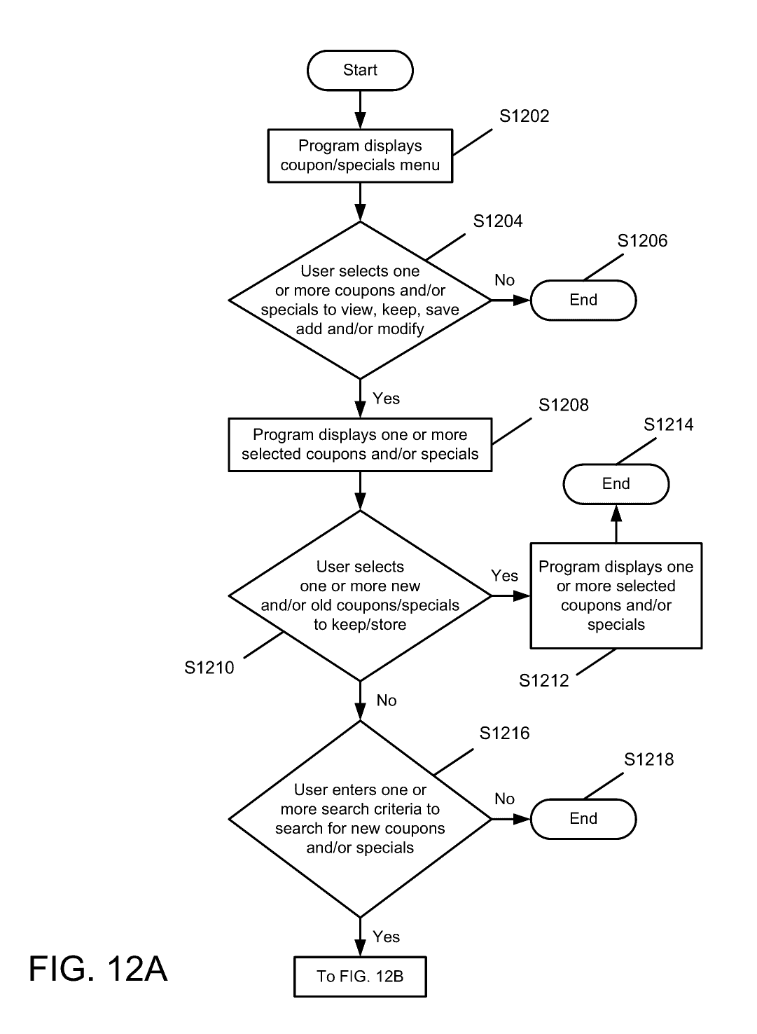

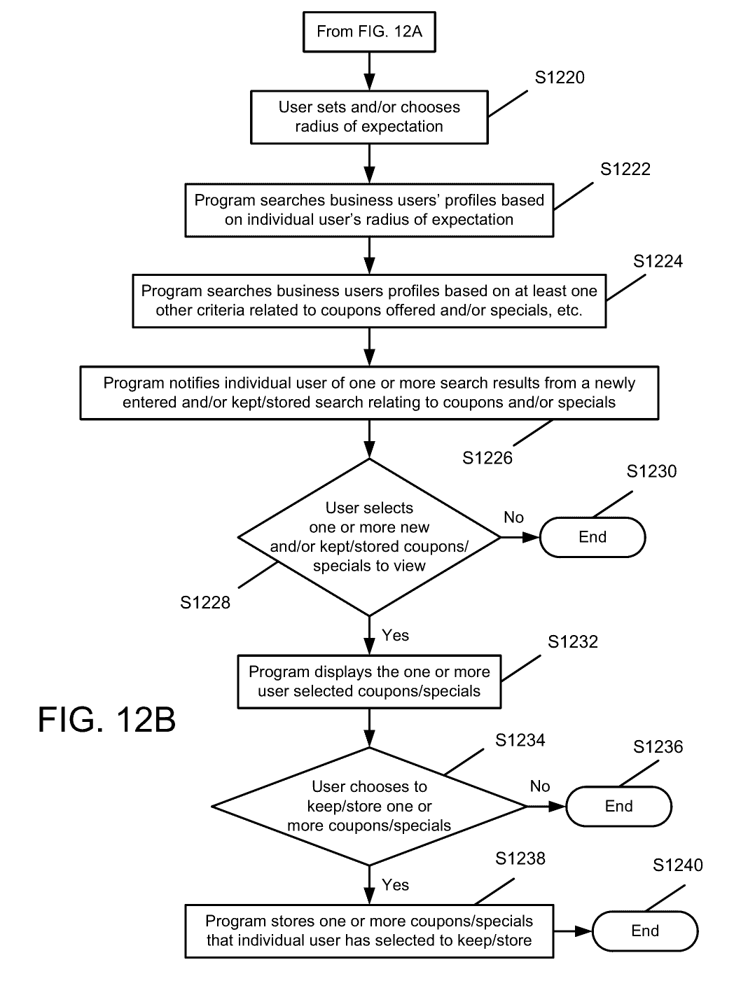

Turning to FIGS. 12A and 12B, FIGS. 12A and 12B together are a flow diagram illustrating an exemplary process that permits an individual user to select, control and/or modify one or more kept/stored specials and/or coupons related to one or more of a business user's place of business and/or one or more social and/or entertainment events/places. Initially at S1202 the program displays the coupons/specials menu to an individual user. Next, at S1204, the program queries the individual user whether or not they want to select one or more coupons and/or specials to view, keep, save, modify and/or add. If the individual user declines to do so, this portion of the program ends at S1206. If the individual user decides to select one or more coupons and/or specials to view, keep, save, modify and/or add, the program displays a list of such items at S1208.

Next, at S1210, the program queries the individual user as to whether they want to modify, add, and/or delete any items from the list generated in S1208. If the individual user elects to do so, the program displays the one or more selected coupons and/or specials to be modified and/or deleted and/or permits the individual user to add one or more new coupons and/or specials at S1212. Once the individual user is done with S1212, this portion of the program ends as S1214. Next, at S1216, the program queries the individual user whether they want to enter one or more search criteria to search for new coupons and/or specials at S1216. If the individual user elects to do so, the program proceeds to prompt the user, at S1220, to either utilize their previously entered and/or determined radius of expectation or to enter a new and/or updated radius of expectation. If the user declines at S1216, this portion of the program ends at S1218.

Next, at S1222, the program searches business users' profiles based on the individual user's radius of expectation and then further searches such profiles based on at least one other criteria relating to coupons and/or specials offered at S1224. After completion of such one or more searches, the program notifies the individual user of the one or more search results from this newly entered search, from a kept/stored search, or even some combination of both at S1226. Next, at S1228, the program queries the individual user as to whether they want to select one or more new coupons and/or specials and/or one or more kept/stored coupons/specials. If the individual user elects not to do so, this portion of the program ends at S1230. If the individual user elects to select at least one coupon/special result from the list generated in S1226, the program displays such one or more selected items in S1232. The program at S1234, then queries the individual user as to whether or not they want to keep/store the one or more selected coupon/special results from S1232. If the individual user elects not to do so, this portion of the program ends at S1236. If the individual user elects to save at least one coupon/special result from the list generated in S1232, the program stores such one or more items at S1238. Thereafter, this portion of the program ends at S1240.

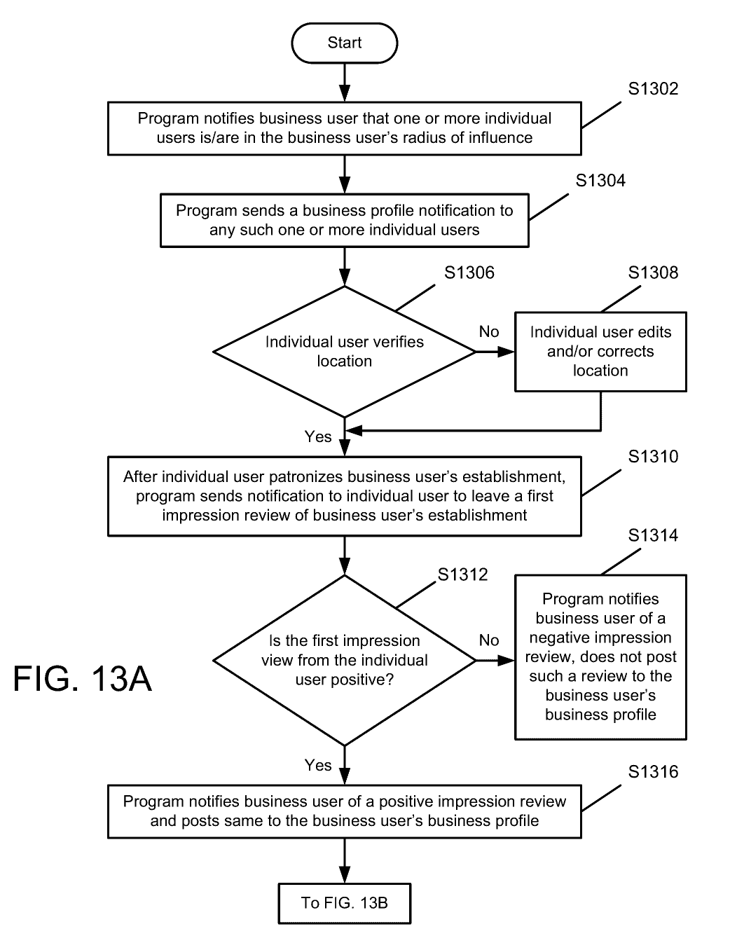

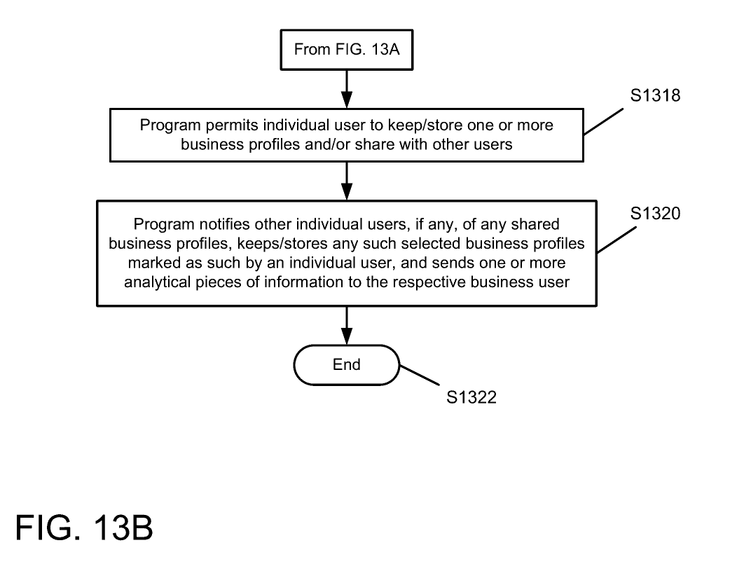

Turning to FIGS. 13A and 13B, FIGS. 13A and 13B, together, are a flow diagram illustrating an exemplary process that permits a business user to be notified that one or more individual users are in the business user's radius of influence. At S1302 the program notifies a business user that one or more individual users is/are in the business user's radius of influence. Then, at S1304, the program sends a business profile notification to any such in range individual users. The program then queries such one or more individual users as to whether or not they want to verify their location and/or to accept such a profile notification from a business user at S1306. If the individual user declines to verify their location, the program at S1308 inquiries as to whether or not the individual user wishes to edit and/or correct their location. Alternatively, although not shown in FIG. 13A, the individual user could decline to do anything further at this point and this portion of the program would then end.

On the other hand, if the individual users does indeed verify their location (or agrees to correct and/or edit their location from S1308) and does in fact attend at least one social and/or entertainment event at the business user's place of business, the program sends, at S1310, a notification to individual user to leave a first impression review of business user's establishment after completion of this event. After the leaving of such a first impression by an individual user, the program determines, at S1312, if this first impression, or review, is positive or negative. If the review is negative, the program notifies the business user of the negative impression and/or review and does not permit the posting of same to the business user's profile at S1314. If the is positive, the program notifies the business user of the positive impression and/or review and posts of same to the business user's profile at S1316. The program further permits the individual user to keep/store any such positively review business profiles and/or share such positively reviewed business profiles with others at S1318. If so shared, the program notifies other individual users of any shared business profiles, keeps/stores any such selected business profiles marked as such by an individual user, and sends one or more analytical pieces of information to the respective business user at S1320. This portion of the program ends at S1322.

Regarding the analytical information that is collected and/or sent by the program, such information can include, but is not limited to, user's age; user's sex; user's date of birth; user's year of birth; user's location; user's ethnicity; user's email; user's items purchased and/or ordered; etc. As would be apparent, the program could enable an individual user to control the dissemination of some of these analytical items for the sake of privacy.

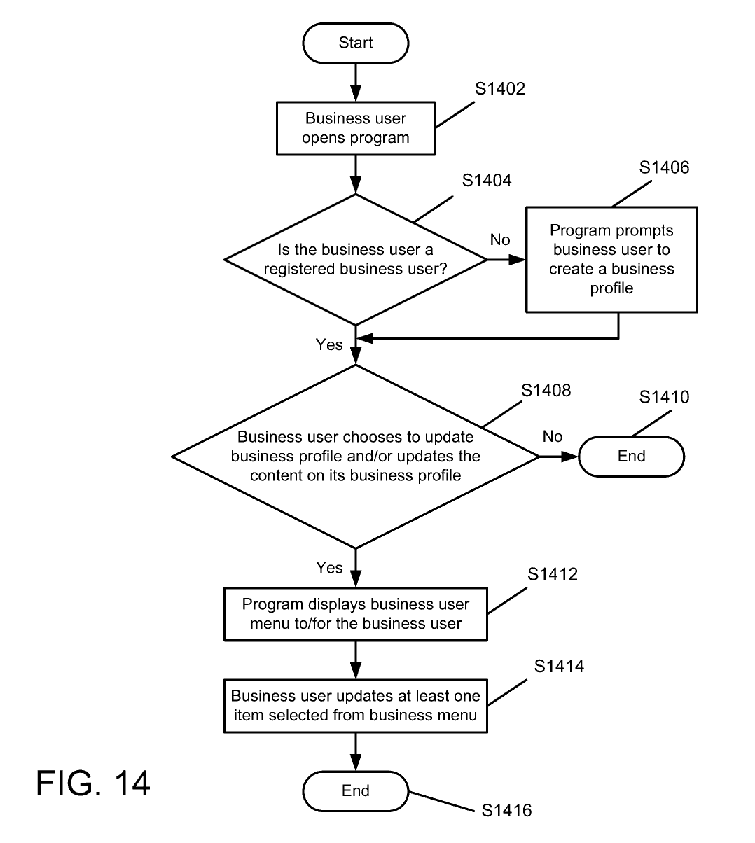

Turing to FIG. 14, FIG. 14 is a flow diagram illustrating an exemplary process that permits a business user to utilize, update and/or create a business profile one notified that one or more individual users are in the business user's radius of influence. At S1402, a business user opens the program. The program then queries at S1404 whether or not the business user is a registered user (this can be designed to only occur the first time a business user opens the program). If the business user is a first time user, the program then prompts such a user to create a business profile at S1406. Such a profile can include one or more pieces of information relating to a business user's one or more places of business including, but not limited to, location, type of entertainment and/or food available, specials and/or coupons available, size of business user's place of business, times of and days of operation, directions to the location (or links to map sites and/or mapping apps such as Google Maps, Apple Maps, MapQuest, etc.), beverage types offered, etc. Alternatively, if the business user is already a registered user, the program then queries whether or not the business user wishes to update their business profile at S1408. If the business user declines to do so, this portion of the program ends at S1410. If the business user decides to update one or more items in their business profile, the program displays the business user profile menu at S1412 and the business user is able to update such one or more items in their profile at S1414. Once updating is completed, this portion of the program ends at S1416.

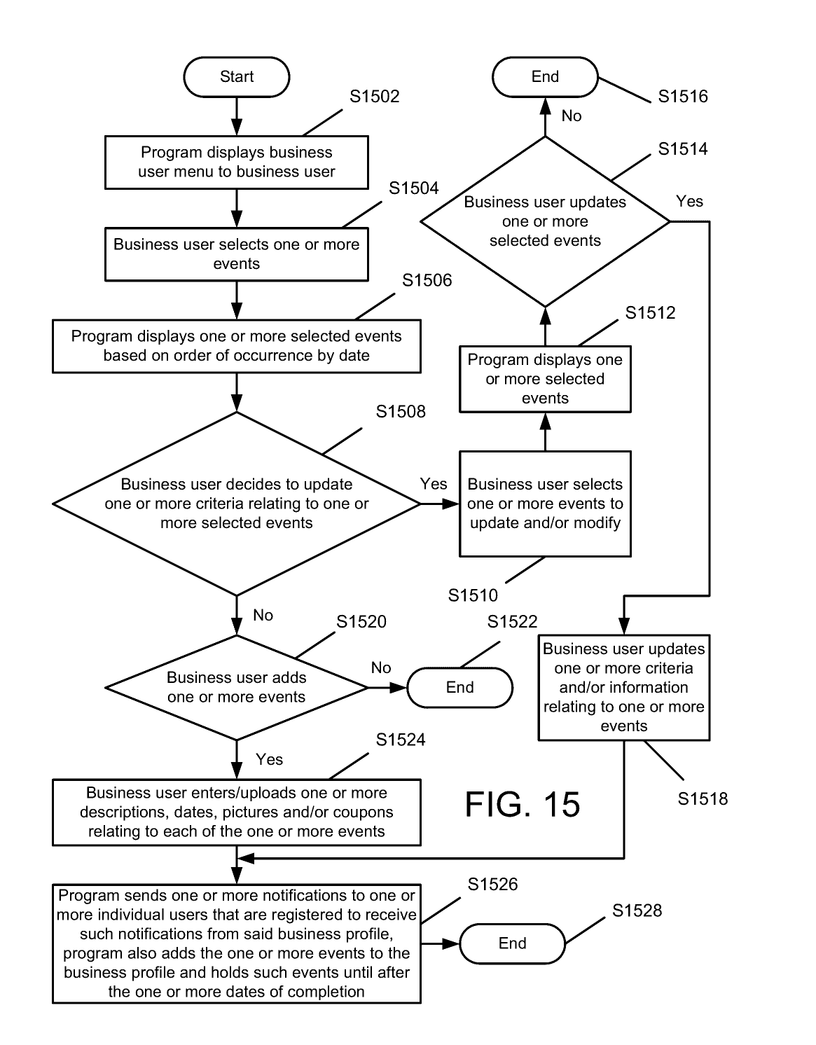

Turing to FIG. 15, FIG. 15 is a flow diagram illustrating an exemplary process that permits a business user to utilize, update and/or create one or more social and/or entertainment events. Initially, after opening the program the program displays business user menu to business user, at S1502, so that the business user can select one or more events at S1504, whereby the program displays such one or more selected events at S1506. Next, at S1508, the program queries the business user as to whether or not they wish to update one or more criteria relating to one or more selected events. If the business user decides to do so, they select, at 1510, the one or more events to update and/or modify. The program displays such selected events at S1512, and queries the business user as to whether such events should indeed be updated at S1514. If at this time, the business user declines to actually update and/or modify any of the selected events this portion of the program ends at S1516. If the business user does indeed confirm the desire to update and/or modify at least one of the selected events, they do so at S1518.

If after query S1508, the business user decides not to update and/or modify any events, the program queries the business user as to whether or not they wish to add one or more new events at S1520. If the business user declines, this portion of the program ends at S1522. If the business user does indeed decide to add one or more new events, then the program prompts the business user to enter/upload one or more descriptions, dates, pictures and/or coupons relating to each of the one or more events at S1524. After all event additions, modifications and/or deletions are completed, the program at S1526 sends one or more notifications to one or more individual users that are registered to receive such notifications from said business profile, adds the one or more events to the business profile and/or holds such events until after the one or more dates of completion. This portion of the program then ends at S1528.

It should be noted that although FIG. 15 illustrates one possible flow of actions related to a portion of the present invention's program, other possible flows and/or modifications thereto are within the scope of the present invention. This same line of reasoning applies equally to all of the other flow diagrams detailing various portions of the present invention.

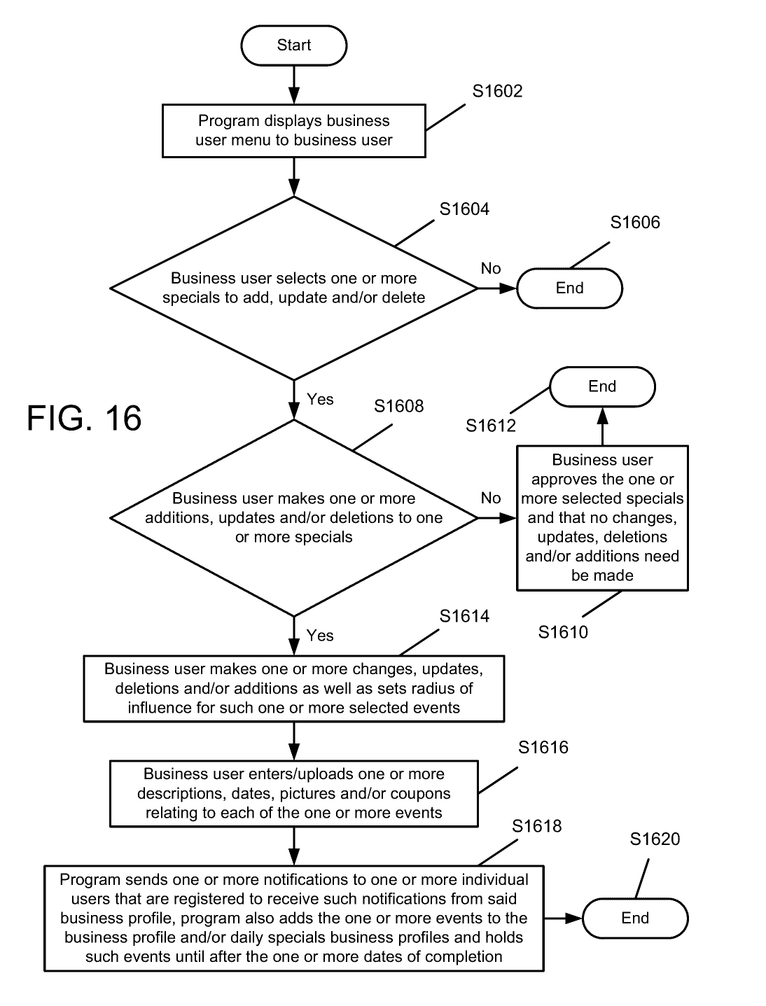

Turning to FIG. 16, FIG. 16 is a flow diagram illustrating an exemplary process that permits a business user to utilize, update and/or create one or more special associated with the business user's one or more places of business and/or one or more specials that are associated with one or more social and/or entertainment events being put on and/or sponsored by the business user. Initially, after opening the program, the program displays a business user menu to a business user at S1602, so that the program can query the business user at S1604 as to whether they wish to select one or more specials (be they daily, weekly, monthly, etc.) to add, update and/or delete. If the business user declines to do so, this portion of the program ends at S1606. If the business user does indeed decide to select one or more specials to add, update and/or delete the business user then either makes changes, or does not, at S1608. If no changes are made to the selected specials (i.e., the business user just wanted to view the selected items for confirmation that the information relating to same is correct), the program then instructs the business user to approve the one or more selected specials and that no changes, updates, deletions and/or additions to such need be made at S1610. Once complete, this portion of the program ends at S1612. If one or more changes are made to such one or more selected specials at S1608, the program and the business user makes one or more changes, updates, deletions and/or additions as well as sets and/or confirms the radius of influence for such one or more selected events at S1614.

Next, at S1616, the business user enters/uploads, if so desired, one or more descriptions, dates, pictures and/or coupons relating to each of the one or more events. After all of the updating and/or additions are completed to the business user's specials, the program sends one or more notifications to one or more individual users that are registered to receive such notifications from said business profile, adds the one or more events to the business profile and/or daily specials business profiles and/or holds such events until after the one or more dates of completion at S1618. This portion of the program then ends at S1620.

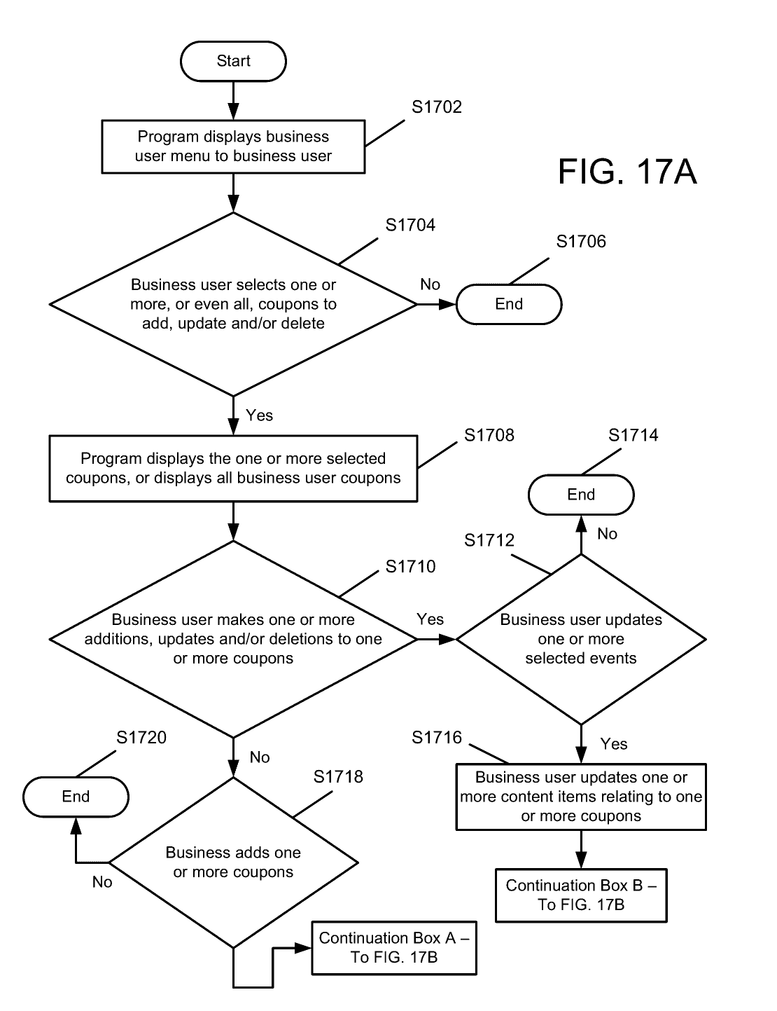

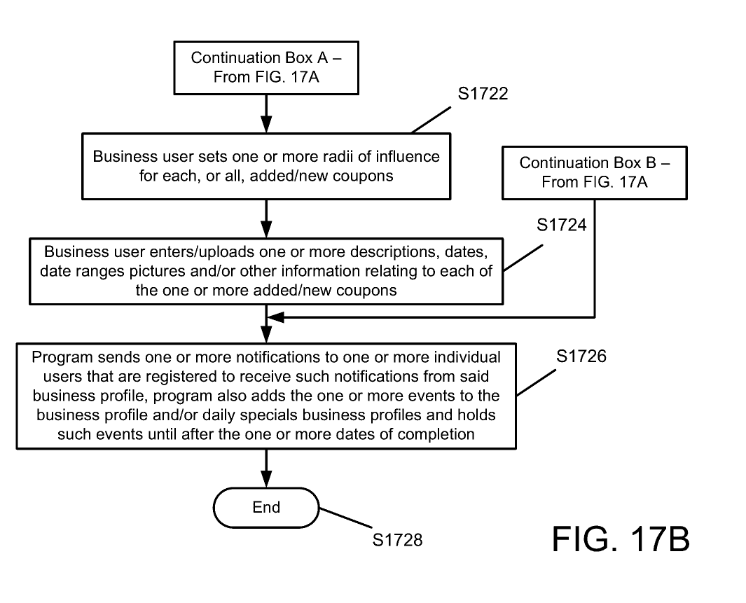

FIGS. 17A and 17B, together, are a flow diagram illustrating an exemplary process that permits a business user to utilize, update and/or create one or more coupons associated with the business user's one or more places of business and/or one or more coupons that are associated with one or more social and/or entertainment events being put on and/or sponsored by the business user. Initially, after opening the program the program displays business user menu to business user at S1702 so that the program can query the business user at S1704 as to whether they wish to select one or more coupons (be they daily, weekly, monthly, etc.) to add, update and/or delete. If the business user declines to do so, this portion of the program ends at S1706. If the business user does indeed decide to select one or more coupons to add, update and/or delete the business user, then the program displays such selected coupons at S1708. Next, the program queries the business use if any changes, additions and/or deletions to such coupons need to be made at S1710. If no changes are made to the selected coupons, the program then queries the business user as to whether or not they wish to add new coupons at S1718. If no coupons are added this portion of the program ends at S1720. If one or more coupons are added in response to query S1718, the business user is then prompted to set the radius of influence for each newly added coupon at S1722. Next, at S1724, the business user enters/uploads one or more descriptions, dates, date ranges pictures and/or other information relating to each of the one or more added/new coupons. The program then sends one or more notifications to one or more individual users that are registered to receive such notifications from said business profile, adds the one or more events to the business profile and/or daily specials business profiles and/or holds such events until after the one or more dates of completion at S1726. This portion of the program ends at S1728.

If after the query at S1710, the business user wishes to make one or more changes, additions and/or deletions to such previous coupons changes are made at S1712, if no changes are in fact made this portion of the program ends at S1714. If the desire to make changes is in fact confirmed, the business user updates one or more content items (including, but not limited to, radius of influence) relating to one or more coupons at S1716. Once this action, or actions, are complete the program then sends one or more notifications to one or more individual users that are registered to receive such notifications from said business profile, adds the one or more events to the business profile and/or daily specials business profiles and/or holds such events until after the one or more dates of completion at S1726. This portion of the program ends at S1728.

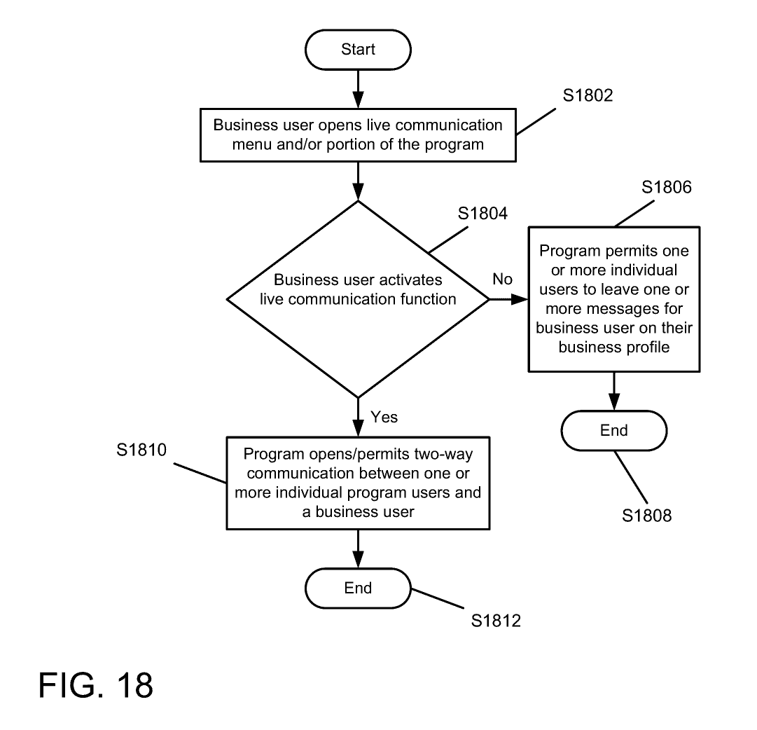

FIG. 18 is a flow diagram illustrating an exemplary process that permits a business user to communicate via one or more of text, live chat, etc. with one or more individual users. Initially, the business user opens the live communication menu at S1802. Thereafter, at S1804, the program queries the business user if they want to in fact activate the live communication portion of the program with one or more individual users. If the business user declines to do so, the program can be designed, at S1806, to permit any individual user to leave one or more messages for the business user on their business profile. This portion of the program then ends at S1808.

If the business user does indeed decide to activate the live communication function, the program opens/permits two-way communication between one or more individual program users (only users that have previously authorized live communication can be contacted) and a business user at S1810. After all such live communications are complete this portion of the program ends at S1812. With regard to the form of such live communications, they typically will take the form of text, messages, emails, videos, or any other form. Text messages and/or emails are preferred.

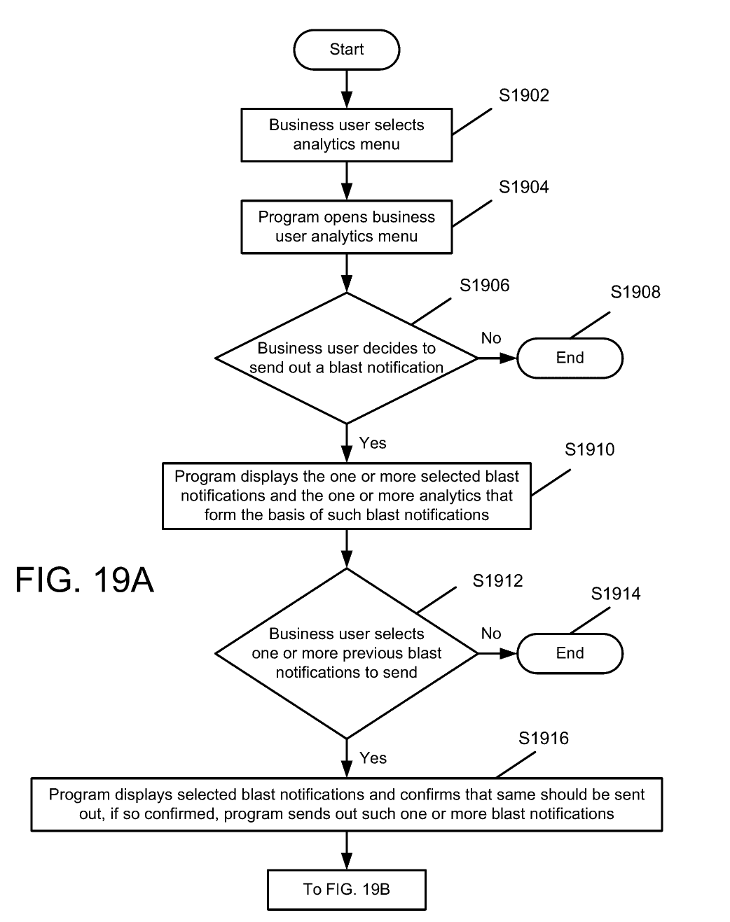

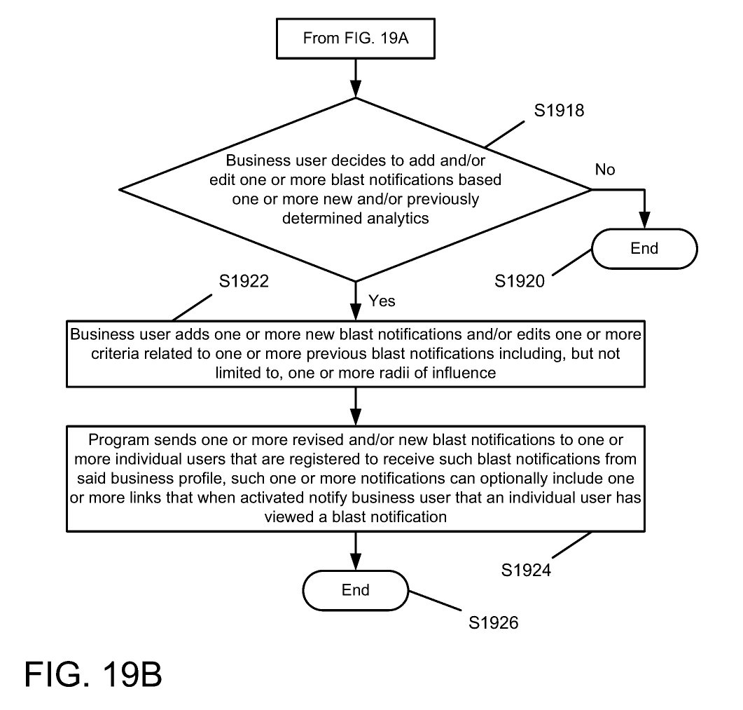

FIGS. 19A and 19B together are a flow diagram illustrating an exemplary process that permits a business user to utilize, update and/or create one or more blast notifications directed to one or more individual users relating to the business user's one or more places of business and/or relating to one or more social and/or entertainment events being put on and/or sponsored by the business user. Initially, a business user selects and opens the analytics menu of the program at S1902 and S1904. Next, the program queries the business user as to whether or not they wish to send out a blast notification at S1906. In this instance, a blast notification is a text message and/or email that is sent to one or more individual users that are currently located within a business user's radius of influence or whose location is set within the business user's radius of influence. Such a blast notification can include any variety of information including, but not limited to, current events taking place, current specials and/or coupons available, etc. If the business user decides against one or more blast notifications, this portion of the program ends at S1908.

If the business user decides to send one or more blast notifications, then the program displays the one or more selected blast notifications and the one or more analytics that form the basis of such blast notifications at S1910. Regarding such analytics, or analytical information, that is collected and/or utilized by the program, such information can include, but is not limited to, user's age; user's sex; user's date of birth; user's year of birth; user's location; user's ethnicity; user's email; user's items purchased and/or ordered; etc. As would be apparent, the program could enable an individual user to control the dissemination of some of these analytical items for the sake of privacy.

At S1912, the program then queries the business user if the desire to send one or more previous blast notifications another time. If the business user declines to do so, this portion of the program ends at S1914. If the business user does indeed wish to send one or more previous blast notifications, the program displays selected blast notifications and confirms that same should be sent out, if so confirmed, program sends out such one or more blast notifications at S1916. At S1918, the program queries the business user as to whether they wish to add and/or edit one or more blast notifications based one or more new and/or previously determined analytics. If the business user declines to do so, this portion of the program ends at S1920.

If the business user does indeed decide to add and/or edit one or more blast notifications based one or more new and/or previously determined analytics, the business user adds one or more new blast notifications and/or edits one or more criteria related to one or more previous blast notifications including, but not limited to, one or more radii of influence at S1922. After all such editing and/or additions are complete, the program sends one or more revised and/or new blast notifications to one or more individual users that are registered to receive such blast notifications from said business profile, such one or more notifications can optionally include one or more links that when activated notify business user that an individual user has viewed a blast notification at S1924. This portion of the program then ends at S1926.

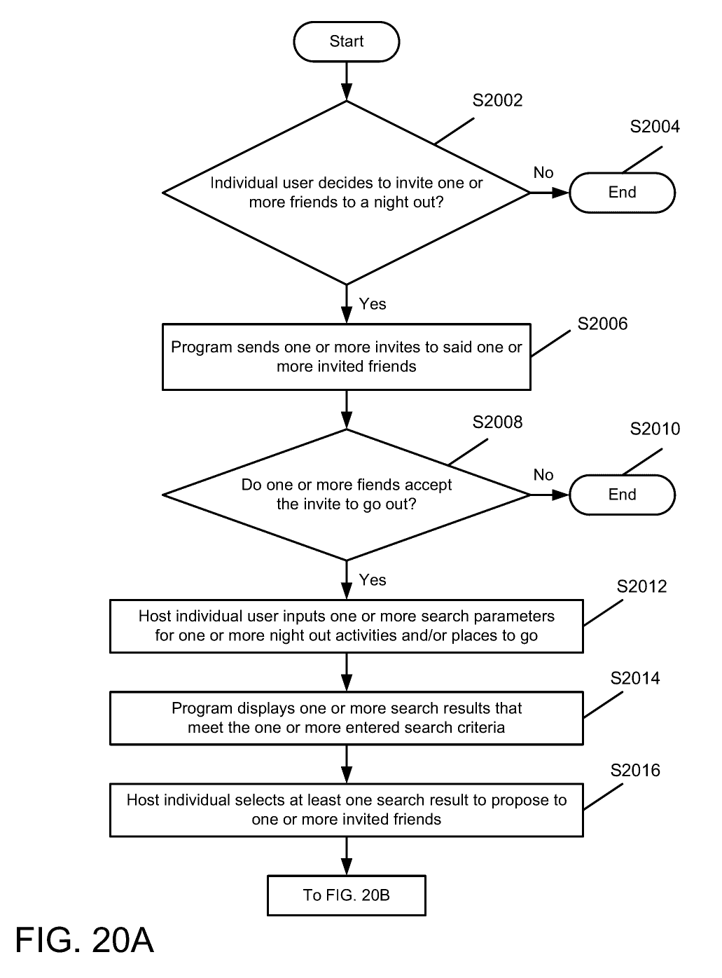

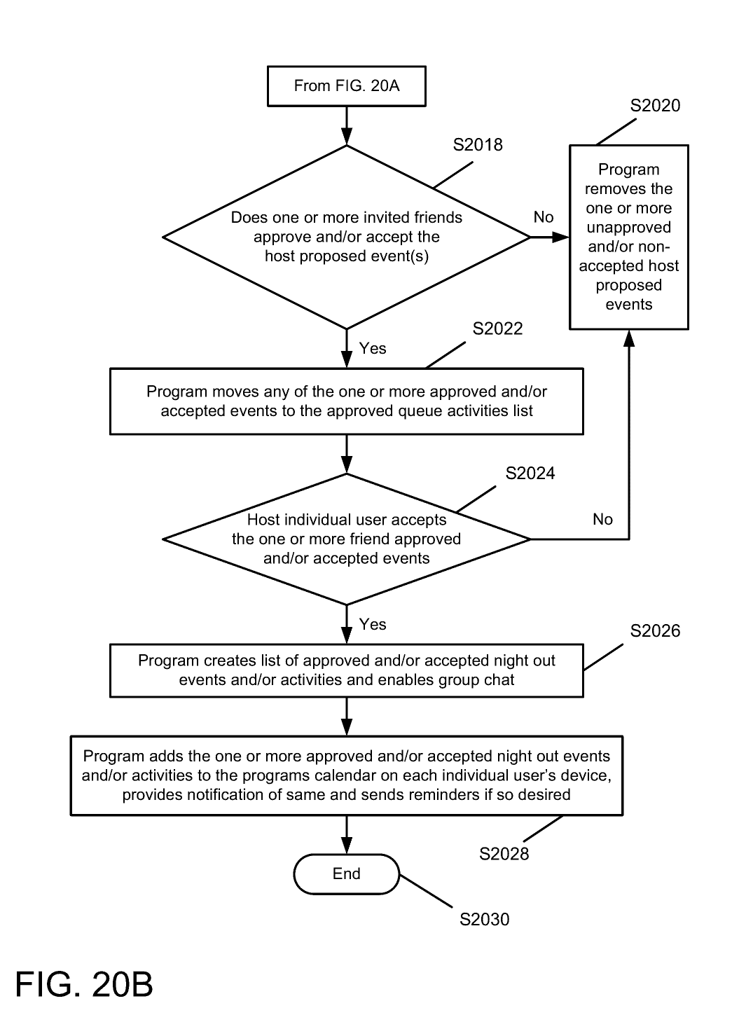

FIGS. 20A and 20B together are a flow diagram illustrating an exemplary process that permits an individual user utilize, update and/or create one or more friend events directed to one or more friends in the individual user's social circle. Initially, an individual user opens the invite portion of the program and is queried by same as to whether they indeed want to invite one or more friends to a night out at S2002. If the individual user decides not to, this portion of the program ends at S2004. If the individual user does indeed confirm their desire to invite one or more friends out, the program sends one or more invites to any one or more invited friends selected to receive same at S2006. The program then waits to see if any one or more of these invited friends accepts the invite to go out at S2008. If not, this portion of the program ends at S2010. If so, at S2012, the program prompts the host individual user to input one or more search parameters so as to find a suitable event and/or place to attend. It should be noted that this step could be eliminated if the host user already has in their kept/stored events an event they wish to invite such one or more friends to. If a search is initiated in S2012, the program, at S2014, displays one or more search results that meet the one or more entered search criteria. Next, at S2016, the host individual selects at least one search result and/or kept/stored event to propose to the one or more invited friends.

Next, the program determines whether or not one or more of the invited friends approve and/or accept the host proposed event(s), If not, the program removes the one or more unapproved and/or non-accepted host proposed events at S2020. If so, the program moves any of the one or more approved and/or accepted events to the approved queue activities list at S2022 and then queries the host individual user as to whether or not they are willing to accept the one or more friend approved and/or accepted events at S2024. If not, the program removes the one or more unapproved and/or non-accepted host proposed events at S2020. If so, the program creates list of approved and/or accepted night out events and/or activities and enables group chat (if so desired by at least two of the users) at S2026. The program also adds the one or more approved and/or accepted night out events and/or activities to the programs calendar on each individual user's device, provides notification of same and sends reminders if so desired at S2028. This portion of the program then ends at S2030.

FIG. 21A is a flow diagram illustrating an exemplary process that permits an individual user to map (e.g., via system 100) one or more other individual users and to communicate via one or more of text, live chat, etc. with any one or more individual users that are checked-in/on-line. Mapping a friend may include, for example, the individual user searching for a location of a friend and a system (e.g., smart phone, etc.) locating the friend. In another aspect, mapping may include causing the system to identify the location of the friend and indicate the location on a display screen, such as via token/indicator on a graphical representation of a geographic map. It is noted that mapping may include determining navigation routes to the friend.

Initially, an individual user opens the maps and friends menu at S2102. Next, the individual user decides whether or not to map one or more friends (e.g., one or more other individual users) from their kept/stored friends list at S2104. If the user decides not to do this, this portion of the program ends at S2106. If the individual user does indeed confirm their desire to map one or more friends from their kept/stored friends list, then the program displays a map containing one or more indicators/links for each of the one or more selected friends to map from user's friends list, where such one or more displayed friends are checked-in/on-line with the program at S2108.

Next, the individual user decides whether or not to select one or more of the displayed indicators/links to one or more checked-in/on-line friends at S2110. If the user decides not to do this, this portion of the program ends at S2112. If the individual user does indeed confirm their desire to select one or more of the displayed indicators/links to one or more checked-in/on-line friends the program displays the profile of or more checked-in/on-line friends at S2114.

Thereafter, the individual user decides whether or not to message one or more of the checked-in/on-line friends (i.e., other individual users) at S2116. If the user decides not to do this, this portion of the program ends at S2118. If the individual user does indeed confirm their desire to message one or more of the checked-in/on-line friends (i.e., other individual users), the program enables communication between the user and one or more checked-in/on-line friends at S2120. This portion of the program then ends at S2122.

Locating a friend may include determining a location of a user device associated with a user identity of the friend. For instance, a system (e.g., system 100) may determine a location of the user device based on a GPS location, triangulation of wireless signals, networks (e.g., local Wi-Fi, NFC, etc.) with which the user devices is connected, “check-ins” (e.g., the friend identifying their location via social media), or the like. It is noted that users may opt in/out of location services, may allow only select or approved others to determine their location, or the like. In one example, a user may control location services through a settings menu or control of their user device. Further, a location may include coordinates (longitude and latitude), a general or range of locations, a venue (e.g., restaurant, theater, etc.), or the like.

FIG. 21B is a flow diagram illustrating an exemplary process that permits an individual user to map (e.g., via system 100) one or more other business users/business profiles and to communicate via one or more of text, live chat, etc. with any one or more business users/business profiles that are checked-in/on-line. Initially, an individual user opens the maps and friends menu at S2132. Next, the individual user decides whether or not to map one or more business user friends from their kept/stored business user friends list at S2134. If the user decides not to do this, this portion of the program ends at S2136. If the individual user does indeed confirm their desire to map one or more business user friends from their kept/stored business user friends list, the program displays (e.g., via a user device) a map containing one or more indicators/links for each of the one or more selected friends to map from user's friends list, where such one or more displayed friends are checked-in/on-line with the program at S2138.

Next, the individual user decides whether or not to select one or more of the displayed indicators/links to one or more checked-in/on-line business user friends at S2140. If the user decides not to do this, this portion of the program ends at S2142. If the individual user does indeed confirm their desire to select one or more of the displayed indicators/links to one or more checked-in/on-line business user friends, the program (e.g., via a user device) displays the profile of or more checked-in/on-line business user friends at S2144.

Thereafter, the individual user decides whether or not to message one or more of the checked-in/on-line business user friends at S2146. If the user decides not to do this, this portion of the program ends at S2148. If the individual user does indeed confirm their desire to message one or more of the checked-in/on-line business user friends, the program enables communication between the user and one or more checked-in/on-line business user friends at S2150. This portion of the program then ends at S2152.

FIG. 22 is a flow diagram illustrating an exemplary process that permits (e.g., via system 100) an individual user to keep/store one or more individual user and/or business user/business profile and to communicate via one or more of text, live chat, etc. with any one or more of such individual users and/or business users/business profiles that are checked-in/on-line. Initially, an individual user opens the kept user menu at S2202. Next, the individual user decides whether or not to keep/store one or more individual users and/or one or more business users/profiles at S2204. If the user decides not to do this, this portion of the program ends at S2206. If the individual user does indeed confirm their desire to keep/store one or more individual users and/or one or more business users/profiles, the program displays one or more lists of the kept/stored individual users and/or one or more business users that are selected to be kept/stored at S2208.

Next, the individual user decides whether or not to select one or more of the kept/stored individual users and/or one or more business users/profiles at S2210. If the user decides not to do this, this portion of the program ends at S2212. If the individual user does indeed confirm their desire to select one or more of the kept/stored individual users and/or one or more business users/profiles the program displays any one or more kept/stored individual users and/or business users that are checked-in/on-line and/or any kept/stored business users that are not on-line (designates those business users that are not on-line to differentiate them from on-line business users, the program also displays (e.g., via a user device) one or more kept/stored events (if any) that any one or more of the kept/stored individual uses are planning to attend at S2214.

Thereafter, the individual user decides whether or not to message one or more of the checked-in/on-line individual users and/or business users/profiles from S2214 at S2216. If the user decides not to do this, this portion of the program ends at S2218. If the individual user does indeed confirm their desire to message one or more of the checked-in/on-line individual users and/or business users/profiles from S2214, the program enables communication between the user and one or more checked-in/on-line friends at S2220. This portion of the program then ends at S2222.

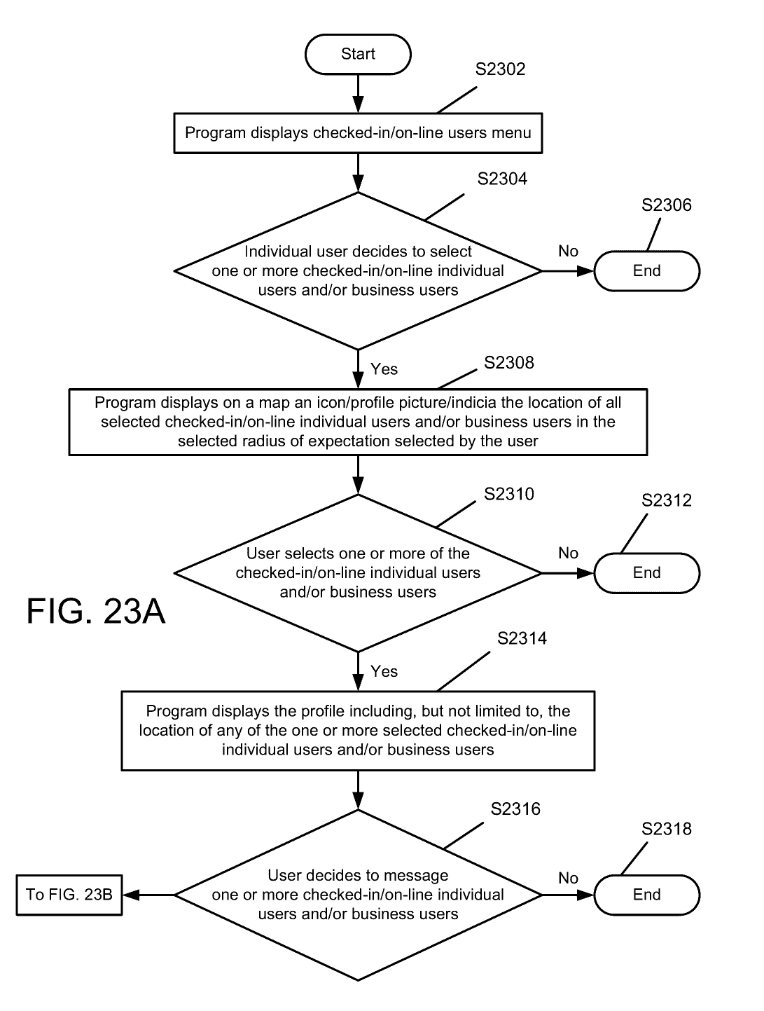

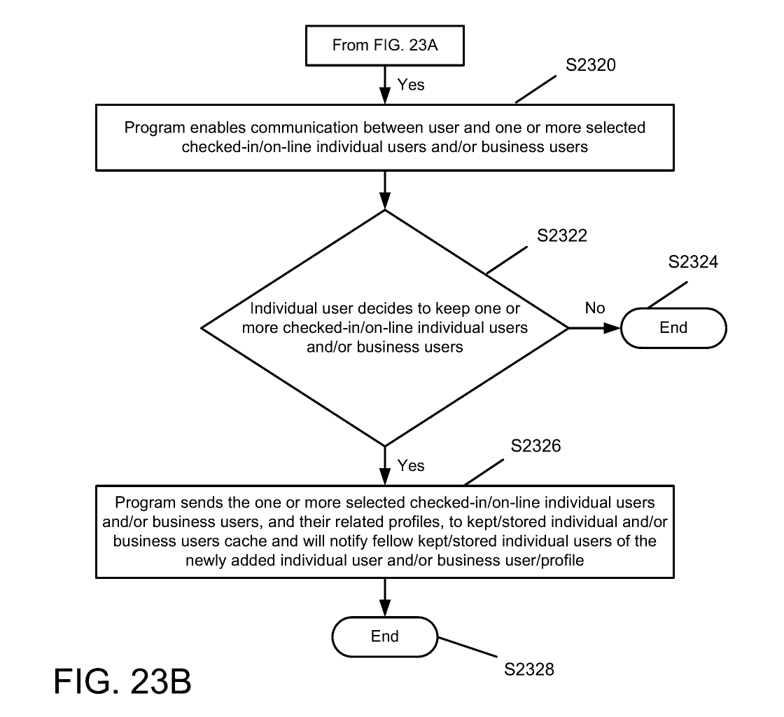

FIGS. 23A and 23B together are a flow diagram illustrating an exemplary process that permits (e.g., via system 100) an individual user to create kept/stored individual user and/or business user lists from those individual users and/or business users that are within a selected radius of expectation and to communicate via one or more of text, live chat, etc. with any one or more of such individual users and/or business users/business profiles that are checked-in/on-line. Initially, an individual user opens and the program displays the checked-in/on-line users menu at S2302. Next, the individual user decides whether or not to select one or more checked-in/on-line individual users and/or business users at S2304. If the user decides not to do this, this portion of the program ends at S2306. If the individual user does indeed confirm their desire to select one or more checked-in/on-line individual users and/or business users, the program displays on a map an icon/profile picture/indicia the location of all selected checked-in/on-line individual users and/or business users in the selected radius of expectation selected by the user at S2308.

Next, the individual user decides whether or not to select user selects one or more of the checked-in/on-line individual users and/or business users at S2310. If the user decides not to do this, this portion of the program ends at S2312. If the individual user does indeed confirm their desire to select user selects one or more of the checked-in/on-line individual users and/or business users the program displays the profile including, but not limited to, the location of any of the one or more selected checked-in/on-line individual users and/or business users at S2314.

Thereafter, the individual user decides whether or not to message one or more of the checked-in/on-line individual users and/or business users/profiles from S3214 at S2316. If the user decides not to do this, this portion of the program ends at S2318. If the individual user does indeed confirm their desire to message one or more of the checked-in/on-line individual users and/or business users/profiles from S2314 the program enables communication between the user and one or more checked-in/on-line friends at S2320. Next, the individual user decides whether or not to keep one or more checked-in/on-line individual users and/or business users at S2322. If the user decides not to do this, this portion of the program ends at S2324. If the individual user does indeed confirm their desire to keep one or more checked-in/on-line individual users and/or business users from S2320, the program sends the one or more selected checked-in/on-line individual users and/or business users, and their related profiles, to kept/stored individual and/or business users cache and will notify fellow kept/stored individual users of the newly added individual user and/or business user/profile at S2326. This portion of the program then ends at S2328.

While embodiments generally refer to a user's current location, it is noted that the various methods and systems described herein may utilize prospective locations. For example, a user may identify where they intend to be at a specific time and/or date (e.g., such as via a calendar). The program may allow a business user to view the user's prospective location. In an aspect, this prospective location may be utilized to determine a radius of expectations. In another aspect, the user may allow the program to analyze a history of travel and/or location data and project a likelihood that the user will be in a specific location (e.g., a restaurant during lunch time). The prospective location may allow a business user to generate a message for the user prior to the user entering the radius of expectation. In some embodiments, the program may allow or prevent sending of the message prior to the radius of expectation and radius of influence overlapping.

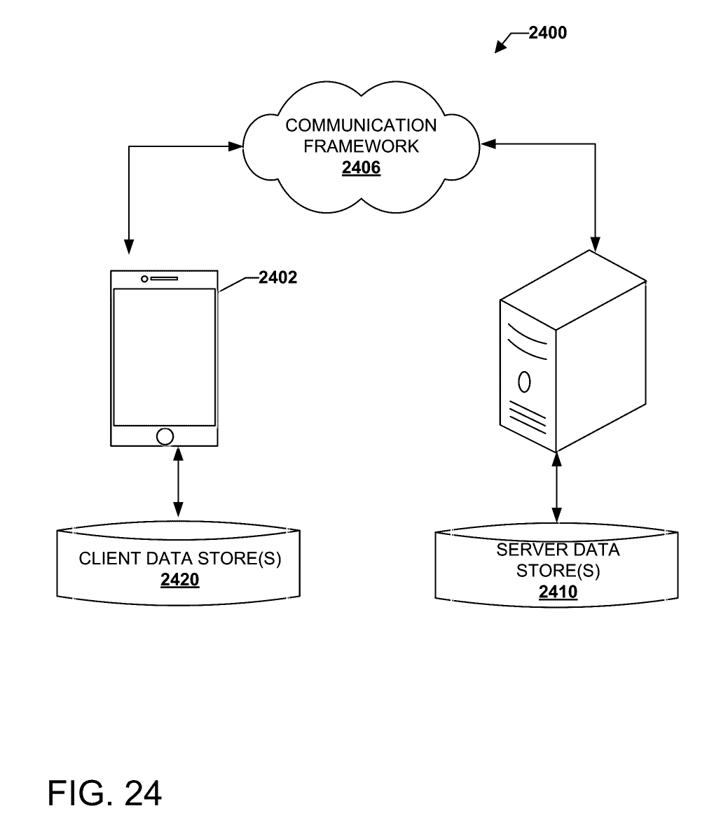

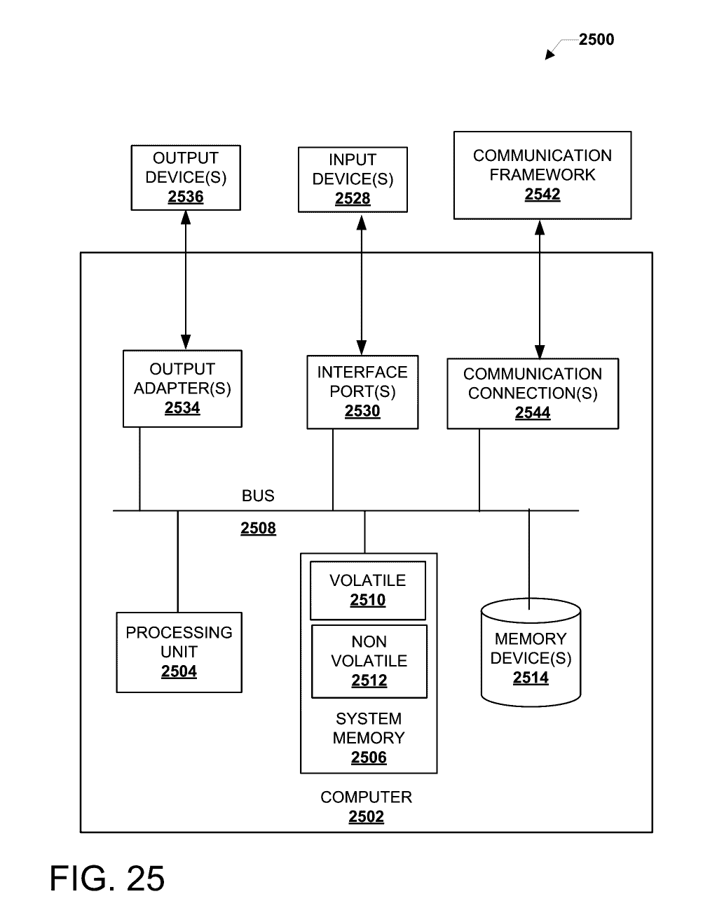

What has been described above may be further understood with reference to the following figures. FIGS. 24 and 25 provide exemplary operating environments or systems capable of implementing one or more systems, apparatuses, or processes described above. FIGS. 24 and 25 are not intended to limit the scope of such systems, apparatuses, or processes. By way of example, computing environment 2400 may refer to one or more embodiment of the various embodiments described with reference to the above figures. However, variations to computing environment 2400 may be obvious to achieve aspects or processes described herein.

FIG. 24 is a schematic diagram of a computing environment 2400 in accordance with various disclosed aspects. It is noted that computing environment 2400 may include various other components or aspects. As depicted, computing environment 2400 may include one or more client(s) 2402, one or more server(s) 2404, one or more client data store(s) 2420, one or more server data store(s) 2410, and a communication framework 2406.

While depicted as a desktop computer(s), client(s) 2402 may include various other devices that may comprise hardware and/or software (e.g., program threads, processes, computer processors, non-transitory memory devices, etc.). In an example, client(s) 2402 may include laptop computers, smart phones, tablet computers, wearables, etc.). The client(s) 2402 may include or employ various aspects disclosed herein. For example, client(s) 2402 may include or employ all or part of various systems and processes disclosed herein.

Likewise, server(s) 2404 may include various devices that may comprise hardware and/or software (e.g., program threads, processes, computer processors, non-transitory memory devices, etc.). Server(s) 2404 may include or employ various aspects disclosed herein. For example, server(s) 2404 may include or employ all or part of various systems and processes disclosed herein. It is noted that server(s) 2404 and client(s) 2402 may communicate via communication framework 2406. In an exemplary communication, client(s) 2402 and server(s) 2404 may utilize packeted data (e.g., data packets) adapted to be transmitted between two or more computers. For instance, data packets may include coded information associated with exercise routines or the likes.

Communication framework 2406 may comprise various network devices (e.g., access points, routers, base stations, etc.) that may facilitate communication between client(s) 2402 and server(s) 2404. It is noted that various forms of communications may be utilized, such as wired (e.g., optical fiber, twisted copper wire, etc.) and/or wireless (e.g., cellular, Wi-Fi, near field communication, etc.) communications.

In various embodiments, client(s) 2402 and server(s) 2404 may respectively include or communicate with one or more client data store(s) 2420 or one or more server data store(s) 2410. The data stores may store data local to client(s) 2402 or server(s) 2404.

In at least one embodiment, a client of client(s) 2402 may transfer data describing an exercise, user account data, ratings, or the likes to a server of server(s) 2404. The server may store the data and/or employ processes to alter the data. For example, the server may transmit the data to other clients of client(s) 2402.

FIG. 25 is a block diagram of a computer system 2500 that may be employed to execute various disclosed embodiments. It is noted that various components may be implemented in combination with computer executable instructions, hardware devices, and/or combinations of hardware and software devices that may be performed by computer system 2500.

Computer system 2500 may include various components, hardware devices, software, software in execution, and the likes. In embodiments, computer system 2500 may include computer 2500. Computer 2500 may include a system bus 2508 that couples various system components. Such components may include a processing unit(s) 2504, system memory device(s) 2506, memory device(s) 2514 (e.g., disk storage device(s), flash memory, etc.), output adapter(s) 2534, interface port(s) 2530, and communication connection(s) 2544. One or more of the various components may be employed to perform aspects or embodiments disclosed herein. In an aspect, the computer system 2500 may “learn,” such as described above user preferences based upon modifications of exercises, feedback associated with satisfaction, or the like. For example, the computer system 2500 may modify a particular exercise routine (or a set thereof) as a number of users have disapproved of the exercise. The computer system 2500 may dynamically push out the revised exercises or receive the revised exercises as applicable.

Processing unit(s) 2504 may comprise various hardware processing devices, such as single-core or multi-core processing devices. Moreover, processing unit(s) 2504 may refer to a “processor,” “controller,” “computing processing unit (CPU),” or the likes. Such terms generally relate to a hardware device. Additionally, processing unit(s) 2504 may include an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or the likes. System memory 2506 may include one or more types of memory, such volatile memory 2510 (e.g., random access memory (RAM)) and non-volatile memory 2512 (e.g., read-only memory (ROM)). ROM may include erasable programmable ROM (EPROM), electrically erasable programmable ROM (EEPROM). In various embodiments, processing unit(s) 2504 may execute computer executable instructions stored in system memory 2506, such as operating system instructions and the likes.

Computer 2502 may also be memory devices 2514 (e.g., EIDE, SATA). While memory device(s) 2514 are depicted as internal to computer 2502, it is noted that memory device(s) 2514 may be external and/or coupled to computer 2502 via remote connections. Moreover, interface port(s) 2530 may include interfaces for coupling to input device(s) 2528, such as disk drives. Disk drives may include components configured to receive, read and/or write to various types of memory devices, such as magnetic disks, optical disks (e.g., compact disks and/or other optical media), flash memory, zip drives, magnetic tapes, and the likes.

It is noted that memory device(s) 2514 and/or disk drives (or non-transitory memory devices in general) may store data and/or computer-executable instructions according to various described embodiments. Such memory devices may also include computer-executable instructions associated with various other programs or modules. For instance, memory device(s) 2514 may include operating system modules, application program modules, and the likes. Moreover, aspects disclosed herein are not limited to a particular operating system, such as a commercially available operating system.

Input device(s) 2528 may also include various user interface devices or other input devices, such as sensors (e.g., microphones, pressure sensors, light sensors, etc.), scales, cameras, scanners, facsimile machines, and the likes. A user interface device may generate instructions associated with user commands. Such instructions may be received by computer 2502. Examples of such interface devices include a keyboard, mouse (e.g., pointing device), joystick, remote controller, gaming controller, touch screen, stylus, and the likes. Interface port(s) 2530 may provide connections for the input device(s) 2528, such as via universal serial ports USB ports), infrared (IR) sensors, serial ports, parallel ports, wireless connections, specialized ports, and the likes.

Output adapter(s) 2534 may include various devices and/or programs that interface with output device(s) 2536. Such output device(s) 2536 may include LEDs, computer monitors, touch screens, televisions, projectors, audio devices, printing devices, or the likes.

In embodiments, computer 2502 may be utilized as a client and/or a server device. As such, computer 2502 may include communication connection(s) 2544 for connecting to a communication framework 2542. Communication connection(s) 2544 may include devices or components capable of connecting to a network. For instance, communication connection(s) 2544 may include cellular antennas, wireless antennas, wired connections, and the likes. Such communication connection(s) 2544 may connect to networks via communication framework 2542. The networks may include wide area networks, local area networks, facility or enterprise wide networks (e.g., intranet), global networks (e.g., Internet), satellite networks, and the likes. Some examples of wireless networks include Wi-Fi, Wi-Fi direct, BLUETOOTH™, Zigbee, and other 802.XX wireless technologies. It is noted that communication framework 2542 may include multiple networks connected together. For instance, a Wi-Fi network may be connected to a wired Ethernet network.

The terms “component,” “module,” “system,” “interface,” “platform,” “service,” “framework,” “connector,” “controller,” or the like are generally intended to refer to a computer-related entity. Such terms may refer to at least one of hardware, software, or software in execution. For example, a component may include a computer process running on a processor, a processor, a device, a process, a computer thread, or the likes. In another aspect, such terms may include both an application running on a processor and a processor. Moreover, such terms may be localized to one computer and/or may be distributed across multiple computers.

The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A computer-implemented method for wireless networking of individual users with one or more business users comprising the steps of:
processing with one or more first wireless computing devices a program that generates one or more individual user geographical locations generated by the one or more first wireless computing devices so as to determine the geographical location of the one or more individual users;
permitting the one or more individual users via processing to set a radius of expectation based on the geographical location of the one or more individual users;
processing with one or more second computing devices a program that generates one or more business user locations generated by the one or more second computing devices so as to determine the location of the one or more business users;
permitting the one or more business users via processing to set a radius of influence based on the geographical location of at least one business location of each of the one or more business users; and
enabling the one or more business users to send one or more pieces of marketing related content to any one or more of the individual users whose radius of expectation overlaps an individual business user's radius of influence.

2. The method of step 1, wherein the one or more pieces of marketing related content comprise one or more of food specials, entertainment special events, coupons, or activities offered.

3. The method of step 1, wherein the one or more pieces of marketing related content comprise the dates and/or locations of one or more of social and/or entertainment events.

4. The method of step 1, wherein the method further comprises the step of:
permitting the one or more business users via processing to communicate with at least one of the one or more individual users when at least one of the one or more individual users are located within the radius of influence of the business user.

5. The method of step 4, wherein the communication is based on at least one of the one or more individual users having selected the one or more business users as a kept/stored business user.

6. A computer-implemented method for wireless networking of individual users with one or more business users comprising the steps of:
processing with one or more first location determining-enabled wireless computing devices a program that generates one or more individual user geographical locations generated by the one or more first location determining -enabled wireless computing devices so as to determine the geographical location of the one or more individual users;
permitting the one or more individual users via processing to set a radius of expectation based on the geographical location of the one or more individual users;
processing with one or more second location determining -enabled computing devices a program that generates one or more business user locations generated by the one or more second location determining -enabled computing devices so as to determine the location of the one or more business users;
permitting the one or more business users via processing to set a radius of influence based on the geographical location of at least one business location of each of the one or more business users; and
enabling the one or more individual users via processing to search for one or more social and/or entertainment events within each individual user's radius of expectation.

7. The method of step 6, wherein the search criteria are selected from one or more of location; date; geographical proximity; specials and/or coupons offered; types of activities, foods and/or entertainment offered.

8. The method of step 6, wherein the method further comprises the step of:
permitting the one or more individual users via processing to keep/store one or more business users profiles.

9. The method of step 6, wherein the method further comprises the step of:
permitting the one or more individual users via processing to communicate with at least one of the one or more business users when an individual user is located within the radius of influence of the business user.

10. A computer-implemented method for wireless networking of a host individual user with one or more invited individual users comprising the steps of:
processing with one or more first GPS-enabled wireless computing devices a program that generates one or more host individual user geographical locations generated by the one or more first GPS-enabled wireless computing devices so as to determine the geographical location of the one or more host individual users;
processing with one or more second GPS-enabled computing devices a program that generates one or more invited individual user locations generated by the one or more second GPS-enabled computing devices so as to determine the location of the one or more invited individual users;
enabling the one or more host individual users via processing to search for one or more social and/or entertainment events within a defined geographical radius from all located users;
enabling the one or more host individual users via processing to invite the one or more invited individual users to at least one social and/or entertainment event; and
enabling the one or more invited individual users via processing to accept or decline attendance at the at least one social and/or entertainment event.

11. A system for wireless networking of individual users with one or more business users comprising:
a memory storing computer executable instructions;
a processor coupled to the memory, and configured to execute the computer executable instructions to perform the following acts:
receiving, from a first computing device associated with a user, a location associated with the first computing device;
receiving, from the first computing devices associated with a user, a geographic area of expectation associate with the user;
determining whether the geographic area of expectation associate with the user is within a geographic area of influence of a business location; and
in response to determining that the geographic area of expectation is within the geographic area of influence, enabling a second computing device associated with a business user that is associated with the business location to send one or more pieces of marketing related content to the first computing device.

12. The system of claim 11, wherein the acts further comprise:
determining the location of the first computing device based on at least one of global positioning satellite data, a network connected to the first computing device, or user input.

13. The system of claim 11, wherein the acts further comprise:
in response to determining that the geographic area of expectation is within the geographic area of influence, initiating a notification to be generated via the second computing device that the first computing device is available to receive one or more pieces of marketing related content.

14. The system of claim 11, wherein the acts further comprise:
in response to determining that the geographic area of expectation is within the geographic area of influence, initiating a notification to be generated via the second computing device that the first computing device is available to receive one or more pieces of marketing related content.
